(19) United States
(12) Patent Application Publication
(10) Pub. No.: US 2024/0227120 A1
(43) Pub. Date: Jul. 11, 2024

(54) UV CURABLE PRINTABLE FORMULATIONS FOR HIGH PERFORMANCE 3D PRINTED CMP PADS

(71) Applicant: Applied Materials, Inc., Santa Clara, CA (US)

(72) Inventors: Sudhakar MADHUSOODHANAN, Pleasanton, CA (US); Xinyi LU, Santa Clara, CA (US); Srikant PATHAK, Diamond Bar, CA (US)

(21) Appl. No.: 18/204,774

(22) Filed: Jun. 1, 2023

Related U.S. Application Data
(60) Provisional application No. 63/434,707, filed on Dec. 22, 2022.

(51) Int. Cl. B24B 37/24; B24B 37/22; B29C 64/112; B33Y 10/00; B33Y 70/00; B33Y 80/00; C08F 20/06; C08F 20/36

(52) U.S. Cl. CPC B24B 37/24; B24B 37/22; B29C 64/112; B33Y 10/00; B33Y 70/00; B33Y 80/00; C08F 20/06; C08F 20/36; B29K 2033/00

(57) ABSTRACT

The disclosure generally relates to polishing pads, methods of manufacturing polishing pads, and formulations for manufacturing polishing pads, and more particularly, to polishing pads used for chemical mechanical polishing (CMP) of a substrate in electronic device processing. In one aspect, a photocurable printing composition containing photopolymerizable compounds and photopolymerization initiator is provided. The photocurable printing composition comprises a urethane acrylate oligomer having a functionality of 2 or more, a nominal viscosity greater than 20,000 cP at 60 degrees Celsius, and a glass transition temperature (Tg) of −4 degrees Celsius or greater, the urethane acrylate oligomer present from about 20% to about 60% by weight based on a total weight of the photopolymerizable compounds. The photocurable printing composition has a viscosity of 20 centipoise or higher at 70 degrees Celsius.

### CROSS-REFERENCE TO RELATED APPLICATIONS

This application claims the benefit of U.S. Provisional Patent Application Ser. No. 63/434,707, filed Dec. 22, 2022, which is incorporated by reference herein in its entirety.

### BACKGROUND

### Field

The disclosure generally relates to polishing pads, methods of manufacturing polishing pads, and formulations for manufacturing polishing pads, and more particularly, to polishing pads used for chemical mechanical polishing (CMP) of a substrate in electronic device processing.

### Description of the Related Art

CMP is used in the manufacturing of high-density integrated circuits to planarize or polish a layer of material deposited on a substrate. A CMP process includes contacting the material layer to be planarized with a polishing pad and moving the polishing pad, the substrate, or both, to create relative movement between the material layer surface and the polishing pad, in the presence of a polishing fluid including abrasive particles, chemically active components, or both.

One common application of a CMP process in semiconductor device manufacturing is planarization of a bulk film, for example pre-metal dielectric (PMD) or interlayer dielectric (ILD) polishing, where underlying two or three-dimensional features create recesses and protrusions in the to be planarized material surface. Other common applications of CMP processes in semiconductor device manufacturing include shallow trench isolation (STI) and interlayer metal interconnect formation, where the CMP process is used to remove the via, contact, or trench fill material (overburden) from the exposed surface (field) of the material layer having the STI or metal interconnect features disposed therein.

Often, polishing pads used in CMP processes are selected based on material properties of the polishing pad and the suitability of those material properties for the specific CMP application. One example material property that affects the performance of a polishing pad for a specific CMP application is the storage modulus of the polishing layer. Generally, polishing pads formed of comparatively harder materials provide superior local planarization performance when compared to polishing pads formed of softer materials. However, polishing pads formed of harder materials are also associated with increased defectivity, such as undesirable scratches in a substrate surface, when compared with softer polishing pads. Unfortunately, conventional polishing pads soften at high temperatures, thus reducing their ability to maintain desirable hardness over a wide temperature range.

Accordingly, there is a need in the art for polishing pads that maintain their material properties and provide stable performance over a wide temperature range.

### SUMMARY

In one aspect, a photocurable printing composition is provided. The photocurable printing composition includes a urethane acrylate oligomer having a functionality of 2 or more, a nominal viscosity greater than 250 cP at 25 degrees Celsius, and a glass transition temperature (Tg) of −4 degrees Celsius or greater. The urethane acrylate oligomer is present from about 20% to about 60% by weight based on a total weight of the photocurable printing composition. The photocurable printing composition further includes an acrylate monomer mixture. The acrylate monomer mixture includes one or more monofunctional monomers selected from isobornyl acrylate, 3,3,5-Trimethylcyclohexyl acrylate (TMCHA), N-Vinyl-2-Pyrrolidone, N,N-Diethyl acrylamide (DEAA) or a combination thereof. The acrylate monomer mixture further includes one or more multifunctional monomers selected from a trifunctional acrylate ester monomer, 1,6-Hexanediol diacrylate, or a combination thereof. The acrylate monomer mixture is present from 40% to 80% by weight based on a total weight of the photocurable printing composition and the photocurable printing composition has a viscosity of 20 centipoise or higher at 70 degrees Celsius. The photocurable printing composition further includes a photoinitiator.

Implementations can include one or more of the following. The photocurable printing composition has a viscosity in a range from about 25 centipoise to about 200 centipoise at 70 degrees Celsius. The urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The urethane acrylate oligomer is present from about 30% to 60% by weight based on a total weight of the photopolymerizable compounds and the composition has a viscosity of 25 centipoise or greater at 70 degrees Celsius. The urethane acrylate oligomer is present from about 45% to 60% by weight based on a total weight of the photopolymerizable compounds and the composition has a viscosity of 82 centipoise or greater at 70 degrees Celsius. The urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). A polishing pad formed from the photocurable printing composition.

In another aspect, a method of forming a polishing pad is provided. The method includes sequentially forming a plurality of polymer layers. Forming the plurality of polymer layers includes forming a first layer of first polishing elements of the polishing pad. Forming the first layer includes dispensing one or more droplets of a pre-polymer composition via an additive manufacturing process on a surface on which the first layer is formed. The pre-polymer composition includes a urethane acrylate oligomer having a functionality of 2 or more, a nominal viscosity greater than 250 cP at 25 degrees Celsius, and a glass transition temperature (Tg) of −4 degrees Celsius or greater. The urethane acrylate oligomer present from about 20% to about 60% by weight based on a total weight of the pre-polymer composition. The pre-polymer composition further includes an acrylate monomer mixture. The acrylate monomer mixture includes one or more monofunctional monomers selected from isobornyl acrylate, 3,3,5-Trimethylcyclohexyl acrylate (TMCHA), N-Vinyl-2-Pyrrolidone, N,N-Diethyl acrylamide (DEAA) or a combination thereof. The acrylate monomer mixture further includes one or more multifunctional monomers selected from a trifunctional acrylate ester monomer, 1,6-Hexanediol diacrylate, or a combination thereof. The acrylate monomer mixture is present from 40% to 80% by weight based on a total weight of the pre-polymer composition and the pre-polymer composition has a viscosity of 20 centipoise or higher at 70 degrees Celsius. The pre-polymer composition further includes a photoinitiator.

Implementations can include one or more of the following. The pre-polymer composition has a viscosity in a range from about 25 centipoise to about 200 centipoise at 70 degrees Celsius. The urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The urethane acrylate oligomer is present from about 30% to 60% by weight based on a total weight of the photopolymerizable compounds and the composition has a viscosity of 25 centipoise or greater at 70 degrees Celsius. The urethane acrylate oligomer is present from about 45% to 60% by weight based on a total weight of the photopolymerizable compounds and the composition has a viscosity of 82 centipoise or greater at 70 degrees Celsius. The urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). A polishing pad formed from the method of forming a polishing pad.

In yet another aspect, a photocurable printing composition containing photopolymerizable compounds and photopolymerization initiator is provided. The photocurable printing composition comprises a urethane acrylate oligomer having a functionality of 2 or more, a nominal viscosity greater than 250 cP at 25 degrees Celsius, and a glass transition temperature (Tg) of −4 degrees Celsius or greater, the urethane acrylate oligomer present from about 20% to about 60% by weight based on a total weight of the photocurable printing composition. The photocurable printing composition further comprises one or more monofunctional acrylate monomers. The one or more monofunctional acrylate monomers comprise isobornyl acrylate present from about 10% to about 20% by weight based on the total weight of the photocurable printing composition, 3,3,5-Trimethylcyclohexyl acrylate (TMCHA) present from about 30% to about 40% by weight based on the total weight of the photocurable printing composition, and N-Vinyl-2-Pyrrolidone present from about 1% to about 10% by weight based on the total weight of the photocurable printing composition. The photocurable printing composition further comprises one or more multifunctional acrylate monomers. The one or more monofunctional acrylate monomers comprise a trifunctional acrylate ester monomer present from about 1% to about 10% by weight based on the total weight of the photocurable printing composition and 1,6-Hexanediol diacrylate present from about 1% to about 10% by weight based on the total weight of the photocurable printing composition. The photocurable printing composition has a viscosity of 10 centipoise or higher at 70 degrees Celsius.

Implementations can include one or more of the following. The photocurable printing composition has a viscosity in a range from about 25 centipoise to about 200 centipoise at 70 degrees Celsius. The urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The urethane acrylate oligomer is present from about 30% to 60% by weight based on a total weight of the photopolymerizable compounds and the composition has a viscosity of 25 centipoise or greater at 70 degrees Celsius. The urethane acrylate oligomer is present from about 45% to 60% by weight based on a total weight of the photopolymerizable compounds and the composition has a viscosity of 82 centipoise or greater at 70 degrees Celsius. The urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). A polishing pad formed from the photocurable printing composition.

In yet another aspect, a polishing pad is provided. The polishing pad comprises a plurality of polishing elements, each comprising an individual surface that forms a portion of a polishing surface of a polishing pad and one or more sidewalls extending downward from the individual surface to define a plurality of channels disposed between the polishing elements. Each of the polishing elements has a plurality of pore-features formed therein. Each of the polishing elements is formed of a pre-polymer composition, the pre-polymer composition comprising a urethane acrylate oligomer. The pre-polymer composition has a Tan delta of about 1 or less and a storage modulus (E′) of the pre-polymer composition at a temperature of 30 degrees Celsius (E′30) is about 1000 MPa or less.

Implementations can include one or more of the following. The Tg of the pre-polymer composition is from about −5 degrees Celsius to about 50 degrees Celsius. The urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The pre-polymer composition further comprises one or more monofunctional acrylate monomers. The one or more monofunctional acrylate monomers comprise isobornyl acrylate (IBXA) present from about 10% to about 20% by weight based on the total weight of the pre-polymer composition. The one or more monofunctional acrylate monomers further comprises 3,3,5-Trimethylcyclohexyl acrylate (TMCHA) present from about 30% to about 40% by weight based on the total weight of the pre-polymer composition. The one or more monofunctional acrylate monomers further comprise N-Vinyl-2-Pyrrolidone present from about 1% to about 10% by weight based on the total weight of the pre-polymer composition. The pre-polymer composition further comprises one or more multifunctional acrylate monomers. The one or more multifunctional acrylate monomers comprises a trifunctional acrylate ester monomer. The trifunctional acrylate ester monomer is Trimethylolpropane triacrylate (TMPTA) present from about 1% to about 10% by weight based on the total weight of the pre-polymer composition. The one or more multifunctional acrylate monomers further comprises 1,6-Hexanediol diacrylate present from about 1% to about 10% by weight based on the total weight of the pre-polymer composition.

In yet another aspect, a method of forming a polishing pad is provided. The method comprises sequentially forming a plurality of polymer layers. Forming the plurality of polymer layers comprises forming a first layer of first polishing elements of the polishing pad. Forming the first layer, comprises dispensing one or more droplets of a pre-polymer composition via an additive manufacturing process on a surface on which the first layer is formed. The pre-polymer composition, comprises photopolymerizable compounds and a photopolymerization initiator, comprising a urethane acrylate oligomer having a functionality of 2 or more, a nominal viscosity greater than 250 cP at 25 degrees Celsius, and a glass transition temperature (Tg) of −4 degrees Celsius or greater, the urethane acrylate oligomer present from about 20% to about 60% by weight based on a total weight of the pre-polymer composition. The pre-polymer composition further comprises one or more monofunctional acrylate monomers, comprising isobornyl acrylate present from about 10% to about 20% by weight based on the total weight of the pre-polymer composition, 3,3,5-Trimethylcyclohexyl acrylate (TMCHA) present from about 30% to about 40% by weight based on the total weight of the pre-polymer composition, and N-Vinyl-2-Pyrrolidone present from about 1% to about 10% by weight based on the total weight of the pre-polymer composition. The pre-polymer composition further comprises one or more multifunctional acrylate monomers, comprising a trifunctional acrylate ester monomer present from about 1% to about 10% by weight based on the total weight of the pre-polymer composition, and 1,6-Hexanediol diacrylate present from about 1% to about 10% by weight based on the total weight of the pre-polymer composition. The pre-polymer composition has a viscosity of 10 centipoise or higher at 70 degrees Celsius.

Implementations can include one or more of the following. The pre-polymer composition has a viscosity in a range from about 25 centipoise to about 200 centipoise at 70 degrees Celsius. The urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The urethane acrylate oligomer is present from about 30% to 60% by weight based on a total weight of the photopolymerizable compounds and the composition has a viscosity of 25 centipoise or greater at 70 degrees Celsius. The urethane acrylate oligomer is present from about 45% to 60% by weight based on a total weight of the photopolymerizable compounds and the composition has a viscosity of 82 centipoise or greater at 70 degrees Celsius. The urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). A polishing pad formed from the method of forming a polishing pad.

In yet another aspect, a photocurable printing composition containing photopolymerizable compounds and photopolymerization initiator is provided. The photocurable printing composition comprises a polyester urethane acrylate oligomer having a functionality of 2 or more, a nominal viscosity greater than 20,000 cP at 60 degrees Celsius, and a glass transition temperature (Tg) of −4 degrees Celsius or greater, the polyester urethane acrylate oligomer present from about 20% to about 60% by weight based on a total weight of the photopolymerizable compounds. The photocurable printing composition further comprises one or more monofunctional acrylate monomers. The one or more functional monomers comprise isobornyl acrylate (IBXA) present from about 20% to about 50% by weight based on the total weight of the photopolymerizable compounds, 3,3,5-Trimethylcyclohexyl acrylate (TMCHA) present from about 5% to about 30% by weight based on the total weight of the photopolymerizable compounds, and N, N-Diethyl acrylamide present from about 1% to about 10% by weight based on the total weight of the photopolymerizable compounds. The photocurable printing composition further comprises one or more multifunctional acrylate monomers comprising a trifunctional acrylate ester monomer present from about 1% to about 10% by weight based on the total weight of the photopolymerizable compounds, wherein the photocurable printing composition has a viscosity of 10 centipoise or higher at 70 degrees Celsius.

Implementations can include one or more of the following. The photocurable printing composition has a viscosity in a range from about 25 centipoise to about 200 centipoise at 70 degrees Celsius. The polyester urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The polyester urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The polyester urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The polyester urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The polyester urethane acrylate oligomer is present from about 30% to 60% by weight based on a total weight of the photopolymerizable compounds and the composition has a viscosity of 25 centipoise or greater at 70 degrees Celsius. The polyester urethane acrylate oligomer is present from about 45% to 60% by weight based on a total weight of the photopolymerizable compounds and the composition has a viscosity of 82 centipoise or greater at 70 degrees Celsius. The polyester urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). The Tg of the pre-polymer composition is from about −5 degrees Celsius to about 50 degrees Celsius. A polishing pad formed from the photocurable printing composition.

In yet another aspect, a polishing pad is provided. The polishing pad comprises a plurality of polishing elements, each comprising an individual surface that forms a portion of a polishing surface of a polishing pad and one or more sidewalls extending downward from the individual surface to define a plurality of channels disposed between the polishing elements. Each of the polishing elements has a plurality of pore-features formed therein. Each of the polishing elements is formed of a pre-polymer composition, the pre-polymer composition comprising a polyester urethane acrylate oligomer. The pre-polymer composition has a Tan of about 1 or less. A storage modulus (E′) of the pre-polymer composition at a temperature of 30 degrees Celsius (E′30) is about 1000 MPa or less.

Implementations can include one or more of the following. The polyester urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The polyester urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The polyester urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The polyester urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The pre-polymer composition further comprises one or more monofunctional acrylate monomers. The one or more monofunctional acrylate monomers comprise isobornyl acrylate (IBXA) present from about 20% to about 50% by weight based on the total weight of the pre-polymer composition. The one or more monofunctional acrylate monomers further comprises 3,3,5-Trimethylcyclohexyl acrylate (TMCHA) present from about 5% to about 25% by weight based on the total weight of the pre-polymer composition. The one or more monofunctional acrylate monomers further comprise N, N-Diethyl acrylamide present from about 1% to about 10% by weight based on the total weight of the pre-polymer composition. The pre-polymer composition further comprises one or more multifunctional acrylate monomers. The one or more multifunctional acrylate monomers comprises a trifunctional acrylate ester monomer. The trifunctional acrylate ester monomer is Trimethylolpropane triacrylate (TMPTA) present from about 1% to about 10% by weight based on the total weight of the pre-polymer composition. The Tg of the pre-polymer composition is from about −5 degrees Celsius to about 50 degrees Celsius.

In yet another aspect, a method of forming a polishing pad is provided. The method comprises sequentially forming a plurality of polymer layers. Forming the plurality of polymer layers comprises forming a first layer of first polishing elements of the polishing pad. Forming the first layer comprises dispensing one or more droplets of a pre-polymer composition via an additive manufacturing process on a surface on which the first layer is formed. The pre-polymer composition comprises photopolymerizable compounds and a photopolymerization initiator. The pre-polymer composition, comprises a polyester urethane acrylate oligomer having a functionality of 2 or more, a nominal viscosity greater than 20,000 cP at 60 degrees Celsius, and a glass transition temperature Tg of −4 degrees Celsius or greater, the polyester urethane acrylate oligomer present from about 20% to about 60% by weight based on a total weight of the photopolymerizable compounds, one or more monofunctional acrylate monomers, comprising isobornyl acrylate (IBXA) present from about 20% to about 50% by weight based on the total weight of the photopolymerizable compounds, 3,3,5-Trimethylcyclohexyl acrylate (TMCHA) present from about 5% to about 30% by weight based on the total weight of the photopolymerizable compounds, and N, N-Diethyl acrylamide present from about 1% to about 10% by weight based on the total weight of the photopolymerizable compounds, and one or more multifunctional acrylate monomers, comprising a trifunctional acrylate ester monomer present from about 1% to about 10% by weight based on the total weight of the photopolymerizable compounds, wherein the photocurable printing composition has a viscosity of 10 centipoise or higher at 70 degrees Celsius.

Implementations can include one or more of the following. The polyester urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius. The polyester urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius. The polyester urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius. The polyester urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius. The polyester urethane acrylate oligomer is present from about 30% to 60% by weight based on a total weight of the photopolymerizable compounds and the composition has a viscosity of 25 centipoise or greater at 70 degrees Celsius. The polyester urethane acrylate oligomer is present from about 45% to 60% by weight based on a total weight of the photopolymerizable compounds and the composition has a viscosity of 82 centipoise or greater at 70 degrees Celsius. The polyester urethane acrylate oligomer is present from about 55% to 60% by weight based on a total weight of the photopolymerizable compounds and the composition has a viscosity of 180 centipoise or greater at 70 degrees Celsius. The trifunctional acrylate ester monomer is trimethylolpropane triacrylate (TMPTA). The Tg of the pre-polymer composition is from about −5 degrees Celsius to about 50 degrees Celsius. A polishing pad formed from the method of forming a polishing pad.

In yet another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above-recited features of the present disclosure can be understood in detail, a more particular description of the disclosure, briefly summarized above, may be had by reference to implementations, some of which are illustrated in the appended drawings. It is to be noted, however, that the appended drawings illustrate only exemplary implementations and are therefore not to be considered limiting of its scope, and may admit to other equally effective implementations.

FIG. 1 is a schematic sectional view illustrating local planarization of a portion of a substrate following a chemical mechanical polishing (CMP) process using a conventional polishing pad.

FIG. 2 is a schematic side view of an exemplary polishing system configured to use a polishing pad formed in accordance with one or more implementations of the present disclosure.

FIG. 3 is a schematic isometric sectional view of a polishing pad, which may be formed using the methods described in accordance with one or more implementations of the present disclosure.

FIG. 4 is a schematic isometric view of a polishing pad in accordance with one or more implementations of the present disclosure.

FIGS. 5A-5F are schematic plan views of various polishing pad designs which may be used in place of the pad design shown in FIG. 4 in accordance with one or more implementations of the present disclosure.

FIG. 6A is a schematic sectional view of an additive manufacturing system, which may be used to form the polishing pads described in accordance with one or more implementations of the present disclosure.

FIG. 6B is a close-up cross-sectional view schematically illustrating a droplet disposed on a surface of a previously formed print layer in accordance with one or more implementations of the present disclosure.

FIG. 7 is a flow chart setting forth a method of forming a polishing pad in accordance with one or more implementations of the present disclosure.

FIGS. 8-10 are diagrams of exemplary polyurethane acrylate oligomers that may be used with the formulations described in accordance with one or more implementations of the present disclosure.

FIG. 11 is an exemplary synthesis of polyurethane acrylate oligomers that may be used with the formulations described in accordance with one or more implementations of the present disclosure.

FIG. 12 is a diagram of examples of difunctional polyols/polythiols and difunctional isocyanates that may be utilized to form polyurethane acrylate oligomers that may be used with the formulations described in accordance with one or more implementations of the present disclosure.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

This disclosure generally relates to polishing pads, and methods of manufacturing polishing pads, and more particularly, to polishing pads used for chemical mechanical polishing (CMP) of a substrate in electronic device processing.

Using higher molecular weight oligomers, a higher amount of oligomer content, or both in a UV curable formulation provides for high UTS/high elongation material that takes advantage of both urethane and acrylic chemistry to enable high performance 3D printed CMP pads. However, using higher molecular weight oligomers, a higher amount of oligomer content or both in a UV curable formulation often significantly increases the viscosity of the UV curable formulation, which can make printing difficult or even impossible. Implementations of the present disclosure provide high viscosity UV curable formulations that are also jettable. The high viscosity UV curable formulations of the present disclosure include UV curable monomers, oligomers, and cross-linkers having a viscosity in a range of 10 to 1000 cP at a print temperature to enable 3D printing of CMP pads with improved properties such as superior pad life and planarity attributes when used in CMP polishing applications.

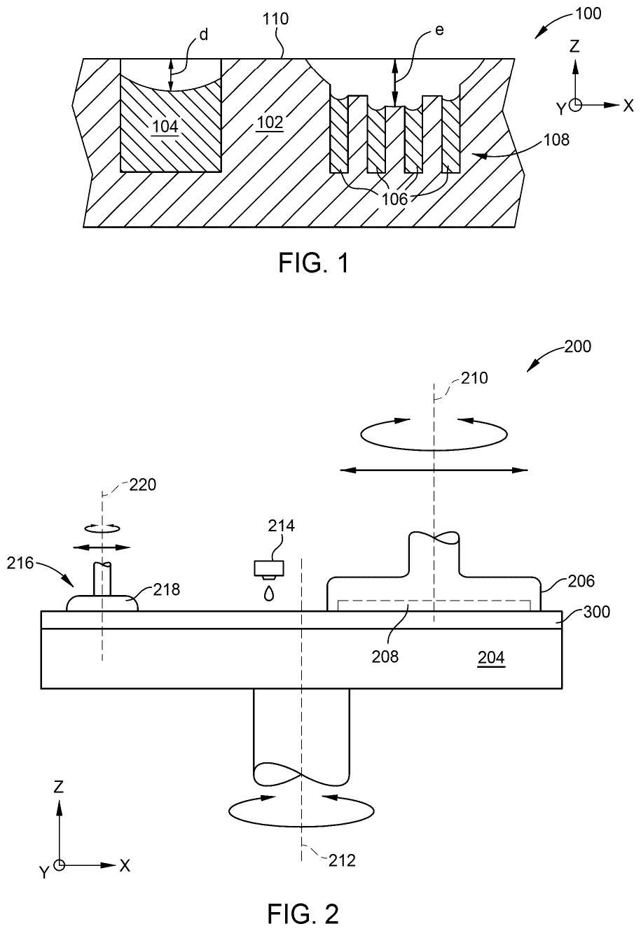

Undesirably poor local planarization performance typically associated with conventional polishing pads formed of relatively softer materials is schematically illustrated in FIG. 1. FIG. 1 is a schematic sectional view illustrating poor local planarization, for example, erosion to a distance “e” and dishing to a distance “d”, following a CMP process to remove an overburden of metal fill material from the field, for example, upper or outer, surface of a substrate 100. Here, the substrate 100 features a dielectric layer 102, a first metal interconnect feature 104 formed in the dielectric layer 102, and a plurality of second metal interconnect features 106 formed in the dielectric layer 102. The plurality of second metal interconnect features 106 are closely arranged to form a region 108 of relatively high feature density. Typically, the metal interconnect features 104, 106 are formed by depositing a metal fill material onto the dielectric layer 102 and into corresponding openings formed therein. The material surface of the substrate 100 is then planarized using a CMP process to remove the overburden of fill material from the field surface 110 of the dielectric layer 102. If the polishing pad selected for the CMP process provides relatively poor local planarization performance, the resulting upper surface of the metal interconnect feature 104 may be recessed a distance “d” from the surrounding surfaces of the dielectric layer 102, otherwise known as dishing. Poor local planarization performance may also result in undesirable recessing of the dielectric layer 102 in the high feature density region 108, for example, distance “e”, where the upper surfaces of the dielectric layer 102 in the region 108 are recessed from the plane of the field surface 110, otherwise known as erosion. Metal loss resulting from dishing and/or erosion can cause undesirable variation in the effective resistance of the metal interconnect features 104, 106 formed therefrom thus affecting device performance and reliability.

In at least one implementation, dishing and erosion are reduced over a wide range of feature sizes compared to conventional polishing pad materials. In addition, some implementations described have more stable or consistent dishing and erosion performance compared to conventional polishing pad materials.

Implementations described provide polishing pad materials having values of glass transition temperature (Tg) that are greater than Tg values for conventional pad materials. In at least one implementation, Tg values are raised by adding high Tg monomers and/or by adding cross-linkers to increase cross-linking density, which increases Tg. In at least one implementation, the greater Tg values of the polishing pad materials described herein provide consistent material properties and stable performance over a wider temperature range, including at higher temperatures, compared to conventional pad materials.

Implementations described provide polishing pads with segmented polishing elements that are disposed on a relatively more compliant foundation layer. Therefore, non-uniformity is reduced compared to conventional pad materials even though the higher Tg values may be expected to increase polishing non-uniformity due to the harder pad materials being less compliant to the surface of the substrate.

Although implementations described are generally related to chemical mechanical polishing (CMP) pads used in semiconductor device manufacturing, the polishing pads and manufacturing methods thereof are also applicable to other polishing processes using both chemically active and chemically inactive polishing fluids and/or polishing fluids free from abrasive particles. In addition, implementations described, alone or in combination, may be used in at least the following industries: aerospace, ceramics, hard disk drive (HDD), MEMS and Nano-Tech, metalworking, optics and electro-optics manufacturing, and semiconductor device manufacturing, among others.

### Exemplary Polishing System

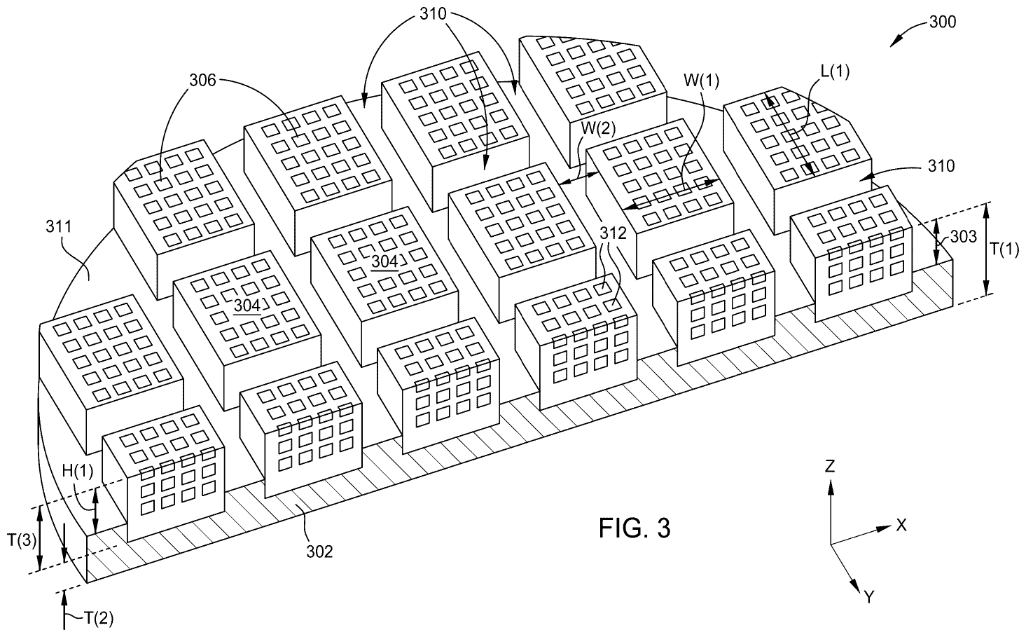

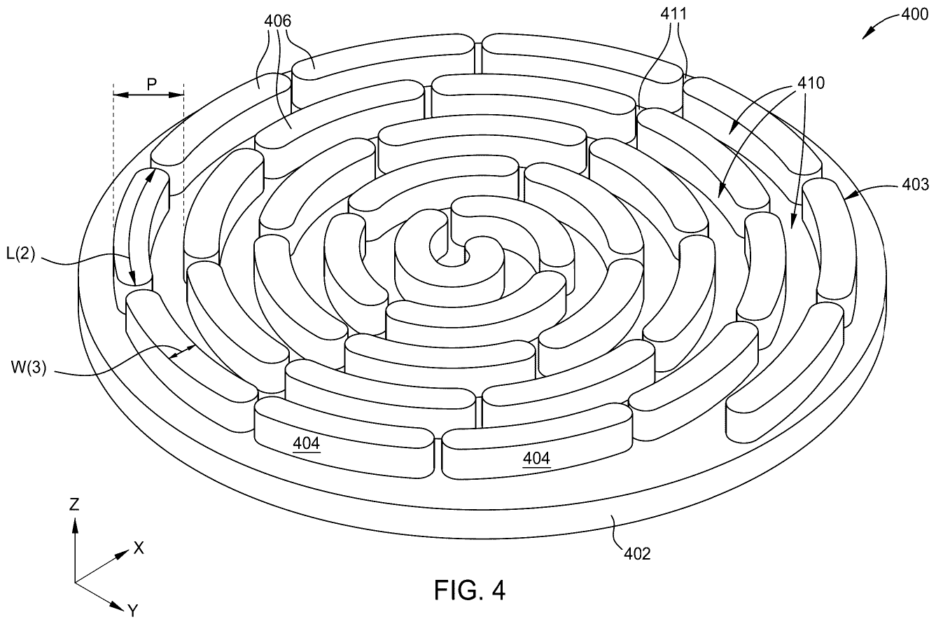

FIG. 2 is a schematic side view of an exemplary polishing system 200 configured to use a polishing pad 300 formed according to implementations described herein. The polishing pad 300 is further described in FIG. 3.

Referring to FIG. 2, the polishing system 200 features a platen 204, having the polishing pad 300 secured thereto using a pressure sensitive adhesive, and a substrate carrier 206. The substrate carrier 206 faces the platen 204 and the polishing pad 300 mounted thereon. The substrate carrier 206 is used to urge a material surface of a substrate 208, disposed therein, against the polishing surface of the polishing pad 300 while simultaneously rotating about a carrier axis 210. Typically, the platen 204 rotates about a platen axis 212 while the rotating substrate carrier 206 sweeps back and forth from an inner diameter to an outer diameter of the platen 204 to in part, reduce uneven wear of the polishing pad 300.

The polishing system 200 further includes a fluid delivery arm 214 and a pad conditioner assembly 216. The fluid delivery arm 214 is positioned over the polishing pad 300 and is used to deliver a polishing fluid, such as a polishing slurry having abrasives suspended therein, to a surface of the polishing pad 300. Typically, the polishing fluid contains a pH adjuster and other chemically active components, such as an oxidizing agent, to enable chemical mechanical polishing of the material surface of the substrate 208. The pad conditioner assembly 216 is used to condition the polishing pad 300 by urging a fixed abrasive conditioning disk 218 against the surface of the polishing pad 300 before, after, or during polishing of the substrate 208. Urging the conditioning disk 218 against the polishing pad 300 includes rotating the conditioning disk 218 about a conditioner axis 220 and sweeping the conditioning disk 218 from an inner diameter the platen 204 to an outer diameter of the platen 204. The conditioning disk 218 is used to abrade and rejuvenate the polishing pad 300 polishing surface, and to remove polish byproducts or other debris from the polishing surface of the polishing pad 300.

### Polishing Pad Examples

The polishing pads described include a foundation layer and a polishing layer disposed on the foundation layer. The polishing layer forms the polishing surface of the polishing pad and the foundation layer provides support for the polishing layer as a to-be-polished substrate is urged against the polishing surface. The foundation layer and the polishing layer can be formed of different pre-polymer compositions that, when cured, have different material properties. The foundation layer and the polishing layer are integrally and sequentially formed using a continuous layer-by-layer additive manufacturing process. The additive manufacturing process provides a polishing pad body having a continuous polymer phase between the polishing layer and the foundation layer thus eliminating the need for an adhesive layer or other bonding method therebetween. In at least one implementation, the polishing layer is formed of a plurality of polishing elements, which are separated from one another across the polishing surface by recesses, and/or channels, disposed therebetween.

The term “pore-feature,” as used herein includes openings defined in the polishing surface, voids that are formed in the polishing material below the polishing surface, pore-forming features disposed in the polishing surface, pore-forming features disposed in polishing material below the polishing surface, and combinations thereof. Pore-forming features typically include a water-soluble-sacrificial material that dissolves upon exposure to a polishing fluid thus forming a corresponding opening in the polishing surface and/or void in the polishing material below the polishing surface. In some implementations, the water-soluble-sacrificial material may swell upon exposure to a polishing fluid thus deforming the surrounding polishing material to provide asperities at the polishing pad material surface. The resulting pores and asperities desirably facilitate transporting liquid and abrasives to the interface between the polishing pad and a to-be-polished material surface of a substrate, and temporarily fixes those abrasives (abrasive capture) in relation to the substrate surface to enable chemical and mechanical material removal therefrom.

In at least one implementation, the polishing material of the polishing pad may be formed from different pre-polymer compositions, or different ratios of the different pre-polymer compositions, to provide unique material properties.

Generally, the methods set forth herein use an additive manufacturing system, for example, a 2D or a 3D printer system, to form (print) at least portions of the polishing pads in a layer-by-layer process. Typically, each print layer is formed (printed) by sequentially depositing and at least partially curing droplets of targeted pre-polymer compositions and/or pore-forming sacrificial material precursor compositions on a manufacturing support or a previously formed print layer. Beneficially, the additive manufacturing system and the methods set forth herein enable at least micron scale droplet placement control within each print layer (X-Y resolution) as well as micron scale (0.1 μm to 200 μm) control over the thickness (Z resolution) of each print layer. The micron scale X-Y and Z resolutions provided by the additive manufacturing systems and the methods set forth herein facilitate the formation of desirable and repeatable patterns of the pore-features described herein. Thus, in at least one implementation, the additive manufacturing methods used to from the polishing pads also impart one or more distinctive structural characteristics of the polishing pads formed therefrom.

FIG. 3 is a schematic isometric sectional view of a polishing pad 300, which may be formed using the methods set forth herein. Here, the polishing pad 300 includes a foundation layer 302 and a polishing layer 303 disposed on the foundation layer 302 and integrally formed therewith using an additive manufacturing process. The additive manufacturing process allows for co-polymerization of different pre-polymer compositions used to respectively form the foundation layer 302 and the polishing layer 303, thus providing a continuous phase of polymer material across the interfacial boundary regions therebetween.

Here, the polishing layer 303 is formed of a plurality of polishing elements 304 that extend upwardly from the foundation layer 302 to form a polishing surface 306. In the illustrated implementations, the plurality of polishing elements 304 are spaced apart from one another to define a plurality of channels 310 therebetween. The plurality of channels 310 are disposed between adjacent ones of the plurality of polishing elements 304 and between a plane of the polishing surface 306 and an upward facing surface 311 of the foundation layer 302. The plurality of channels 310 facilitate the distribution of polishing fluids across the polishing pad 300 and to an interface between the polishing surface 306 and a material surface of a substrate to be polished thereon. The plurality of polishing elements 304 are supported in a thickness direction (Z-direction) of the polishing pad 300 by a portion of the foundation layer 302. Thus, when a load is applied to the polishing surface 306 by a substrate urged against the polishing surface 306, the load will be transmitted through the polishing elements 304 and to the portion of the foundation layer 302 disposed beneath the polishing elements 304.

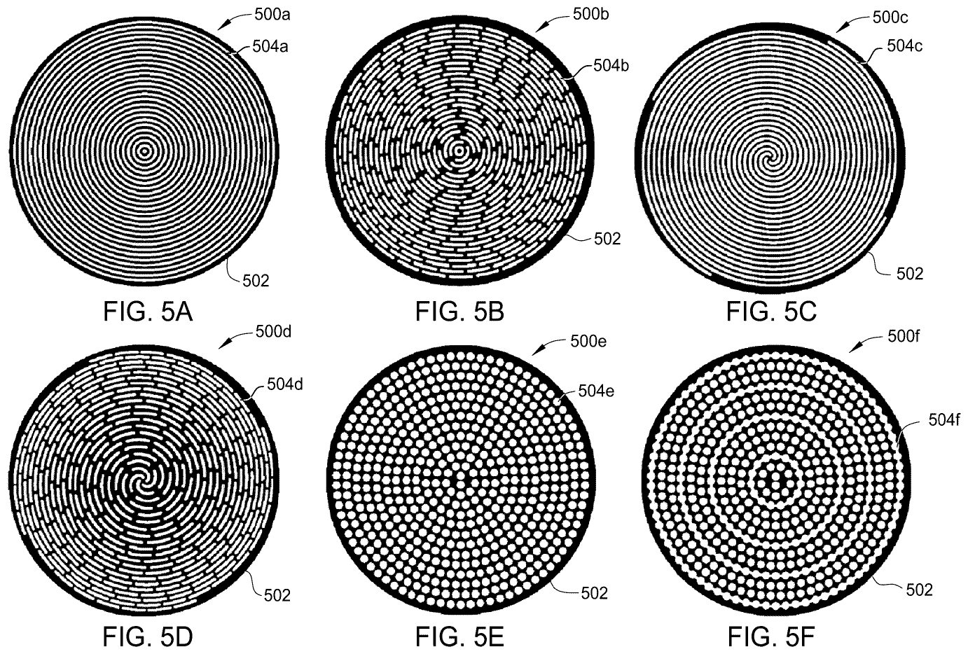

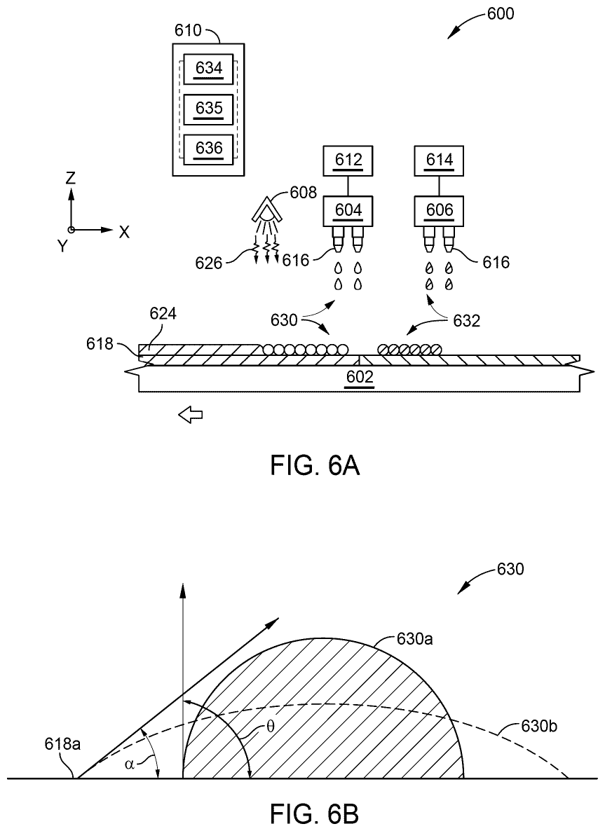

Here, the plurality of polishing elements 304 are formed to have a substantially rectangular shape (square as shown) when viewed from top down and are arranged so that the plurality of channels 310 defined therebetween form an X-Y grid pattern. Alternate shapes and/or arrangements of polishing elements that may be used for the polishing elements 304, and the channels 310 defined therefrom, are illustrated in FIG. 4 and FIGS. 5A-5F. In at least one implementation, the shapes, dimensions, and/or arrangements of the polishing elements 304, and/or the channels 310 disposed between the polishing elements 304, are varied across the polishing pad 300 to tune hardness, mechanical strength, fluid transport characteristics, and/or other desirable properties thereof. In at least one implementation, the polishing layer 303 may not include discrete polishing elements and/or channels 310 defined between polishing surfaces of adjacent polishing elements may not extend through to the foundation layer 302.

Here, the polishing pad 300 has a first thickness T(1) measured between a platen mounting surface and the polishing surface 306 of between about 5 mm and about 30 mm. The foundation layer 302 has a second thickness T(2) of between about ⅓ to about ⅔ of the first thickness T(1). The polishing elements 304 have a third thickness T(3) that is between about ⅓ and about ⅔ of the first thickness T(1). As shown, at least a portion of the polishing elements 304 extend through an X-Y plane of the upward facing surface 311 of the foundation layer 302 to a location inside the foundation layer 302. The remaining portion of the polishing elements 304 extend upwardly or outwardly of the foundation layer 302 by a height H(1) from the X-Y plane of the upward facing surface 311 of the foundation layer 302. The height H(1) of the polishing elements 304 defines a depth of the channels 310 interposed between the polishing elements 304. In at least one implementation, the height H(1) of the polishing elements 304, and thus the depth of the channels 310, is about ½ of the first thickness T(1) or less. In at least one implementation, a height H(1) of the polishing elements 304, and thus the depth of the channels 310, is about 15 mm or less, such as about 10 mm or less, about 5 mm or less, or between about 100 μm and about 5 mm, such as about 800 μm.

Here, at least one lateral dimension of the polishing elements 304, for example, one or both of W(1) and L(1) when viewed from above, is in a range from about 5 mm to about 30 mm, or in a range from about 5 mm to about 20 mm, or in a range from about 5 mm to about 15 mm. The upper surfaces of the polishing elements 304 are parallel to the X-Y plane and form a polishing surface 306, which together form the total polishing surface of the polishing pad 300. Sidewalls of the polishing elements 304 are substantially vertical (orthogonal to the X-Y plane), such as within about 20° of vertical, or within 10° of vertical. Individual ones of the plurality of polishing elements 304 are spaced apart from one another in the X-Y plane by a width W(2) of the individual channels 310 defined between the polishing elements 304. Here, the width W(2) of the individual channels 310 is more than about 100 μm and less than about 5 mm, such as less than about 4 mm, less than about 3 mm, less than about 2 mm, or less than about 1 mm. In at least one implementation, one or both of the lateral dimensions W(1) and L(1) of the polishing elements 304 and/or the width W(2) of the individual channels 310 vary across a radius of the polishing pad 300 to allow fine tuning of the polishing performance thereof.

The polishing elements 304 include a plurality of pore-features 312 disposed therein. The plurality of pore-features 312 may be disposed in any targeted vertical arrangement when viewed in cross-section. For example, in FIG. 3, the plurality of pore-features 312 are vertically disposed in columnar arrangements where the pore-features 312 in each of the columns are in substantial vertical alignment. In some other examples, groups of rows or individual rows of pore-features 312 in the depth direction of the polishing elements 304 may be offset in one or both of X-Y directions to provide corresponding pore-features 312 below the polishing surface 306 that are vertically staggered with respect to the pore-features 312 disposed there above and/or there below. The orientation of the pore-features 312 can be advantageously used to adjust the compliance of the polishing material with respect to a direction of the load exerted by a substrate that is being polished thereon. Thus, in one example, the staggered pore-features 312 may be advantageously used to adjust and/or control the polishing planarization performance of a polishing pad formed therefrom.

In at least one aspect, the individual pore-features 312 may have a height of about 600 μm or less, such as about 500 μm or less, about 400 μm or less, about 300 μm or less, about 200 μm or less, about 100 μm or less, about 50 μm or less, about 40 μm or less, about 30 μm or less, about 20 μm or less, or about 10 μm or less. The height of individual pore-features 312 is typically a multiple, for example, 1× or more, of a thickness of the each of the print layers. For example, the thickness of the pore-features within a print layer may be the same as the thickness of the continuous polymer phase of polishing material disposed adjacent thereto. Thus, if pore-features laterally disposed within at least two sequentially deposited print layers are aligned or at least partially overlap in the Z-direction, the thickness of the resulting pore-feature is at least the combined thickness of the at least two sequentially deposited print layers. In at least one implementation, one or more of the pore-features do not overlap with a pore-feature in an adjacent layer disposed there above or there below and thus has a thickness of a single print layer.

In at least one implementation, the individual pore-features 312 are formed to have lateral dimensions, for example, length/width or diameter, measured in an X-Y plane of about 600 μm or less, such as about 500 μm or less, about 400 μm or less, about 300 μm or less, about 200 μm or less, about 100 μm or less, about 50 μm or less, about 40 μm or less, about 30 μm or less, about 20 μm or less, or about 10 μm or less and about 5 μm or more, such as about 10 μm or more, about 25 μm or more, or about 50 μm or more. In at least one implementation, the mean lateral dimensions of the individual pore-features 312 are in a range from about 50 μm to about 600 μm. In at least one implementation, the pore-features 312 are formed to be relatively narrow in the X-Y plane compared to the height thereof, for example, in some implementations, lateral dimensions of the individual pore-features are about ⅔ or less than the height thereof, such as about ½ or less, or about ⅓ or less.

Here, individual ones of the plurality of pore-features 312 are spaced apart in the vertical direction by one or more printed layers of polymer material formed between the plurality of pore-features 312. In some examples, spacing between pore-features 312 in a vertical direction may be about 100 μm or less, such as about 40 μm or less, such as about 10 μm or less, or about 10 μm to about 40 μm. The pore-features 312 may form a substantially closed-celled structure once the sacrificial-material used to form the pore-features is removed therefrom. In one example, spacing between pore-features 312 in the vertical direction may be about 40 μm. The 40 μm spacing can be formed by disposing four 10 μm print layers of the polymer material between the printed layers that include the pore-features 312. In another example, spacing between pore-features 312 in the vertical direction may be about 10 μm. The 10 μm spacing can be formed by disposing four 2.5 μm print layers of the polymer material between the printed layers that include the pore-features 312.

In other implementations, one or more of the pore-features 312, or portions thereof, are not spaced apart from one or more of the pore-features 312 adjacent thereto and thus form a more open-celled structure once the sacrificial-material is removed therefrom. A thickness of the one or more printed layers may be about 5 μm or more, such as about 10 μm or more, 20 μm or more, 30 μm or more, 40 μm or more, or 50 μm or more. The individual pore-features 312 may be formed within a corresponding single print layer and thus have a height corresponding to the thickness of the print layer or may be formed within two or more adjacent print layers to provide a pore height corresponding to the cumulative thickness thereof.

In at least one implementation, the polishing elements 304 are formed of a continuous polymer phase of polymer material. The polymer material may have a relatively low storage modulus (E′), for example, a soft pad material, a relatively high storage modulus E′, for example, a hard pad material, or a relatively medium storage modulus E′ between the relatively low and relatively high storage modulus, i.e, a medium pad material. In some examples, the polymer material may have a generally homogenous material composition. In some other examples, the polymer material may include at least two pre-polymer compositions, and thus include a combination of low, medium, or high storage modulus E′ materials with a difference from one another in one or more material properties. Characterizations of the low, medium, and high storage modulus E′ materials at a temperature of about 30° C. (E′30) and 90° C. (E′90) are summarized in Table IV.

FIG. 4 schematically illustrates a polishing pad 400 featuring alternate shapes for the polishing elements 404 formed thereon, according to some implementations. FIG. 4 is a schematic isometric view of the polishing pad 400. Features of the polishing pad 400 may be incorporated into or combined with any of the features of the polishing pad 300 described above.

Here, the polishing pad 400 includes a foundation layer 402 and a polishing layer 403 disposed on the foundation layer 402 and integrally formed therewith to provide a continuous phase of polymer material across the interfacial boundary regions therebetween. The polishing layer 403 is formed of a plurality of discrete polishing elements 404 disposed on or partially within the foundation layer 402. The plurality of polishing elements 404 extend upwardly from an upward facing surface 411 of the foundation layer 402 to form a polishing surface 406. The plurality of polishing elements 404 are spaced apart from one another to define a plurality of channels 410 therebetween. Here, the plurality of polishing elements 404 are arranged to form corresponding segments of a spiral pattern. The spiral pattern extends from an inner radius of the polishing pad 400 to an outer radius proximate to the circumference of the polishing pad 400. Here, individual ones of the plurality of polishing elements have an arc length L(2) of between about 2 mm and about 200 mm and a width W(3) of between about 200 μm and about 10 mm, such as between about 1 mm and about 5 mm. A pitch “P” between the maximum radius sidewalls of radially adjacent polishing elements 404 may be between about 0.5 mm and about 20 mm, such as between about 0.5 mm and about 10 mm. In at least one implementation, one or both of the arc length L(2), the width W(3), and the pitch “P” vary across a radius of the polishing pad 400 to define regions of different localized polishing performance.

FIGS. 5A-5F are schematic plan views of polishing pads 500a-f having various shapes and/or arrangements of polishing elements 504a-f that may be used in combination with or in place of any of the other polishing element shapes and/or arrangements described herein. Each of the FIGS. 5A-5F includes a pixel chart having white regions (regions in white pixels) that represent the polishing elements 504a-f and black regions (regions in black pixels) that represent the foundation layer 502, as viewed from above.

In FIG. 5A, the polishing elements 504a include a plurality of concentric annular rings. In FIG. 5B, the polishing elements 504b include a plurality of segments of concentric annular rings. In FIG. 5C, the polishing elements 504c form a plurality of spirals (four shown) extending from a center of the polishing pad 500c to an edge of the polishing pad 500c or proximate thereto. In FIG. 5D, a plurality of discontinuous polishing elements 504d are arranged in a spiral pattern on the foundation layer 502.

In FIG. 5E, each of the plurality of polishing elements 504e includes a cylindrical post extending upwardly from the foundation layer 502. In other implementations, the polishing elements 504e are of any suitable cross-sectional shape, for example columns with toroidal, partial toroidal, for example, arc, oval, square, rectangular, triangular, polygonal, irregular shapes in a section cut generally parallel to the underside surface of the pad 500e, or combinations thereof. FIG. 5F illustrates a polishing pad 500f having a plurality of discrete polishing elements 504f extending upwardly from the foundation layer 502. The polishing pad 500f of FIG. 5F is similar to the polishing pad 500e except that some of the polishing elements 504f are connected to form one or more closed circles. The one or more closed circles create damns to retain polishing fluid during a CMP process.

### Additive Manufacturing System

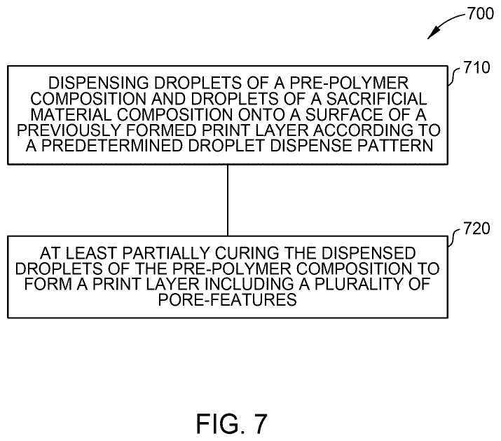

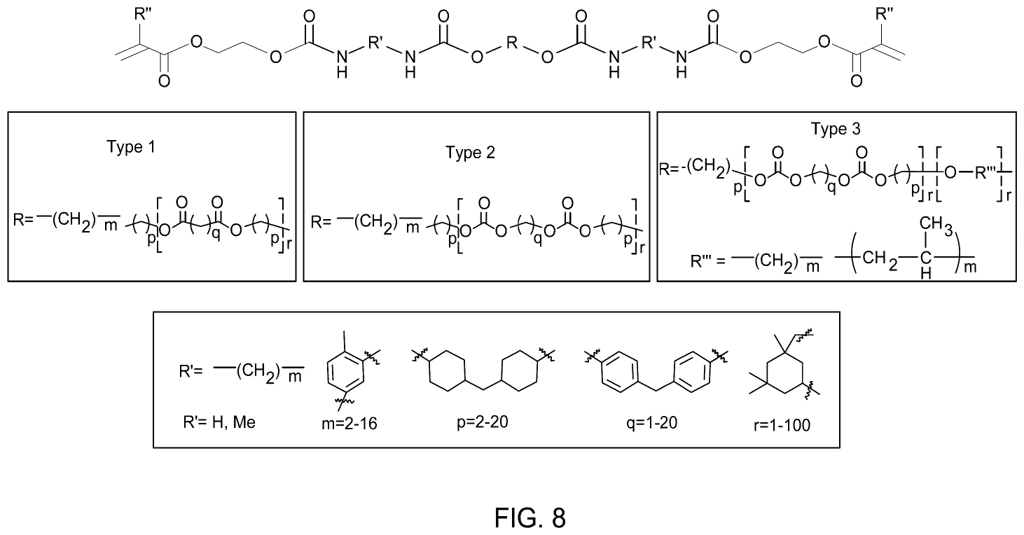

FIG. 6A is a schematic sectional view of an additive manufacturing system, which may be used to form the polishing pads described herein, according to some implementations. Here, the additive manufacturing system 600 features a movable manufacturing support 602, a plurality of dispense heads 604 and 606 disposed above the manufacturing support 602, a curing source 608, and a system controller 610. In at least one implementation, the dispense heads 604, 606 move independently of one another and independently of the manufacturing support 602 during the polishing pad manufacturing process. Here, the first and second dispense heads 604 and 606 are respectively fluidly coupled to a first pre-polymer composition 612 and a sacrificial material composition 614. In at least one implementation, at least one of the first and second dispense heads 604 and 606 is adapted to deposit a high viscosity pre polymer-composition. Typically, the additive manufacturing system 600 features at least one more dispense heads, for example, a third dispense head (not shown), which is fluidly coupled to a second pre-polymer composition source used to form a foundation layer. In at least one implementation, the additive manufacturing system 600 includes as many dispense heads as wanted to each dispense a different pre-polymer composition or sacrificial material precursor composition. In at least one implementation, the additive manufacturing system 600 further includes pluralities of dispense heads where two or more dispense heads are configured to dispense the same pre-polymer compositions or sacrificial material precursor compositions.

Here, each of dispense heads 604, 606 features an array of droplet ejecting nozzles 616 configured to eject droplets 630, 632 of the respective pre-polymer composition 612 and sacrificial material composition 614 delivered to the dispense head reservoirs. Here, the droplets 630, 632 are ejected towards the manufacturing support 602 and thus onto the manufacturing support 602 or onto a previously formed print layer 618 disposed on the manufacturing support 602. Typically, each of dispense heads 604, 606 is configured to fire (control the ejection of) droplets 630, 632 from each of the nozzles 616 in a respective geometric array or pattern independently of the firing of other nozzles 616 thereof. Herein, the nozzles 616 are independently fired according to a droplet dispense pattern for a print layer to be formed, such as the print layer 624, as the dispense heads 604, 606 move relative to the manufacturing support 602. Once dispensed, the droplets 630 of the pre-polymer composition 612 and/or the droplets 632 of the sacrificial material composition 614 are at least partially cured by exposure to electromagnetic radiation by the curing source 608. For example, UV radiation 626, provided by the curing source 608, to form a print layer, such as the partially formed print layer 624.

Here, the additive manufacturing system 600 shown in FIG. 6A further includes the system controller 610 to direct the operation thereof. The system controller 610 includes a programmable central processing unit (CPU) 634, which is operable with a memory 635, for example, a non-volatile memory, and support circuits 636. The support circuits 636 are conventionally coupled to the CPU 634 and include cache, clock circuits, input/output subsystems, power supplies, and the like, and combinations thereof coupled to the various components of the additive manufacturing system 600, to facilitate control thereof. The CPU 634 is one of any form of general-purpose computer processor used in an industrial setting, such as a programmable logic controller (PLC), for controlling various components and sub-processors of the additive manufacturing system 600. The memory 635, coupled to the CPU 634, is non-transitory and is typically one or more of readily available memories such as random access memory (RAM), read only memory (ROM), floppy disk drive, hard disk, or any other form of digital storage, local or remote.

Typically, the memory 635 is in the form of a computer-readable storage medium containing instructions, for example, non-volatile memory, which when executed by the CPU 634, facilitates the operation of the additive manufacturing system 600. The instructions in the memory 635 are in the form of a program product such as a program that implements the methods of the present disclosure, for example, the method 700.

The program code may conform to any one of a number of different programming languages. In one example, the disclosure may be implemented as a program product stored on computer-readable storage media for use with a computer system. The program(s) of the program product define functions of the implementations (including the methods described herein).

Illustrative computer-readable storage media include, but are not limited to: (i) non-writable storage media (e.g, read-only memory devices within a computer such as CD-ROM disks readable by a CD-ROM drive, flash memory, ROM chips or any type of solid-state non-volatile semiconductor memory) on which information is permanently stored; and (ii) writable storage media (e.g, floppy disks within a diskette drive or hard-disk drive or any type of solid-state random-access semiconductor memory) on which alterable information is stored. Such computer-readable storage media, when carrying computer-readable instructions that direct the functions of the methods described herein, are implementations of the present disclosure. In at least one implementation, the methods set forth herein, or portions thereof are performed by one or more application specific integrated circuits (ASICs), field-programmable gate arrays (FPGAs), or other types of hardware implementations. In some other implementations, the polishing pad manufacturing methods set forth herein are performed by a combination of software routines, ASIC(s), FPGAs and, or, other types of hardware implementations.

Here, the system controller 610 directs the motion of the manufacturing support 602, the motion of the dispense heads 604 and 606, the firing of the nozzles 616 to eject droplets of pre-polymer compositions therefrom, and the degree and timing of the curing of the dispensed droplets provided by the UV radiation source 608. In at least one implementation, the instructions used by the system controller to direct the operation of the additive manufacturing system 600 include droplet dispense patterns for each of the print layers to be formed. In some implementations, the droplet dispense patterns are collectively stored in the memory 635 as CAD-compatible digital printing instructions.

In at least one implementation, dispensed droplets of the pre-polymer compositions, such as the dispensed droplets 630 of the pre-polymer composition 612, are exposed to electromagnetic radiation to physically fix the droplet before it spreads to an equilibrium size such as set forth in the description of FIG. 6B. Typically, the dispensed droplets are exposed to electromagnetic radiation to at least partially cure the pre-polymer compositions thereof within one second or less of the droplet contacting a surface, such as the surface of the manufacturing support 602 or of a previously formed print layer 618 disposed on the manufacturing support 602.

FIG. 6B is a close up cross-sectional view schematically illustrating a droplet 630 disposed on a surface 618a of a previously formed layer, such as the previously formed print layer 618 described in FIG. 6A, according to some implementations. In a typical additive manufacturing process, a droplet of pre-polymer composition, such as the droplet 630, spreads and reaches an equilibrium contact angle α with the surface 618a of the previously formed layer within about one second from the moment in time that the droplet 630 contacts the surface 618a. The equilibrium contact angle α is a function of at least the material properties of the pre-polymer composition and the energy at the surface 618a (surface energy) of the previously formed layer. In at least one implementation, it is desirable to at least partially cure the dispensed droplet before it reaches an equilibrium size in order to fix the droplet's contact angle with the surface 618a of the previously formed layer. In those implementations, the fixed droplet's 630a contact angle θ is greater than the equilibrium contact angle α of the droplet 630b (shown in phantom) of the same pre-polymer composition, which was allowed to spread to its equilibrium size.

Herein, at least partially curing a dispensed droplet causes at least partial polymerization, for example, cross-linking, of the pre-polymer composition(s) within the droplets and with adjacently disposed droplets of the same or different pre-polymer compositions to form a continuous polymer phase. In some implementations, the pre-polymer compositions are dispensed and at least partially cured to form a well about a targeted pore before a sacrificial material composition is dispensed within the well.

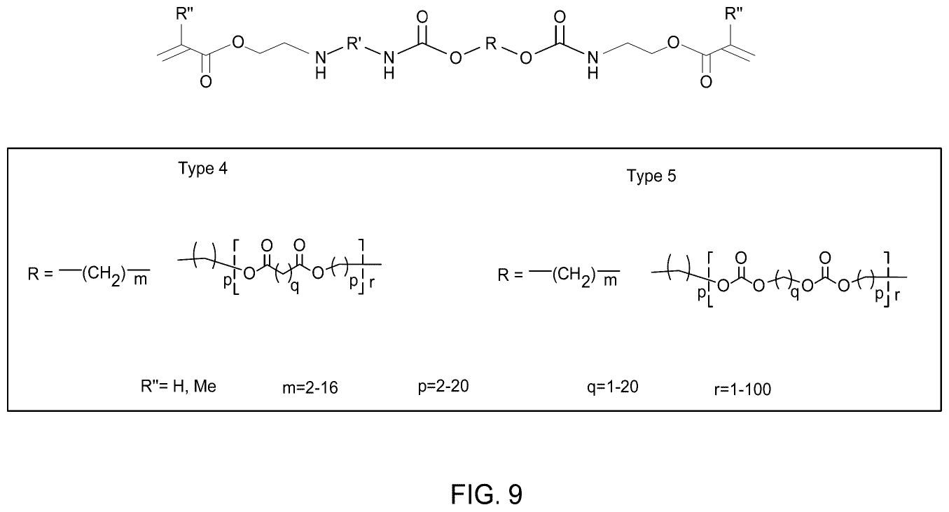

FIG. 7 is a flow chart setting forth a method of forming a polishing pad in accordance with one or more implementations of the present disclosure. Implementations of the method 700 may be used in combination with one or more of the systems and system operations described herein, such as the additive manufacturing system 600 of FIG. 6A and the fixed droplets of FIG. 6B. Further, embodiments of the method 700 may be used to form any one or combination of implementations of the polishing pads shown and described herein.

At operation 710, the method 700 includes dispensing droplets of a pre-polymer composition as described and droplets of a sacrificial material composition onto a surface of a previously formed print layer according to a predetermined droplet dispense pattern.

At operation 720, the method 700 includes at least partially curing the dispensed droplets of the pre-polymer composition to form a print layer including a plurality of pore-features.

In some implementations, the method 700 further includes sequential repetitions of operations 710 and 720 to form a plurality of print layers stacked in a Z-direction, i.e, a direction orthogonal to the surface of the manufacturing support or a previously formed print layer disposed thereon. The predetermined droplet dispense pattern used to form each print layer may be the same or different as a predetermined droplet dispense pattern used to form a previous print layer disposed there below. In some embodiments, the plurality of print layers include a polishing layer having a plurality of pore-features formed therein. In some embodiments, the plurality of print layers include a polishing layer having a plurality of pore-forming features formed therein in which the plurality of pore-forming features include the sacrificial material composition.

### Formulation and Material Examples

The polishing pad described may be formed from at least the pre-polymer composition, which is also referred to as a photocurable printing composition, described. The photocurable printing composition is an ink-jettable and high viscosity pre-polymer composition. The photocurable printing composition which contains at least photopolymerizable compounds and a photopolymerization initiator is explained in detail. There are compounds that fall under two or more categories of the compounds listed below. Such compounds are treated as belonging to each of these two or more categories and counted multiple times toward the contents of the respective categories.

In at least one implementation, the photocurable printing composition has a viscosity in a range from about 10 cP to about 1000 cP at print temperature, for example, 70 degrees Celsius. The viscosity of the photocurable printing composition may be at least 10 cP, 13 cP, 20 cP, 25 cP, 30 cP, 40 cP, 50 cP, 60 cP, 70 cP, 75 cP, 80 cP, 82 CP, 90 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, or 950 cP. The viscosity of the photocurable printing composition may be at most 13 cP, 20 cP, 25 cP, 30 cP, 40 cP, 50 cP, 60 cP, 70 cP, 75 cP, 80 cP, 82 cP, 90 cP, 100 cP, 150 cP, 200 cP, 250 cP, 300 cP, 350 cP, 400 cP, 450 cP, 500 cP, 550 cP, 600 cP, 650 cP, 700 cP, 750 cP, 800 cP, 850 cP, 900 cP, 950 cP, or 1000 cP. In another implementation, the viscosity of the photocurable printing composition is in a range from about 20 cP to about 250 cP, or in a range from about 25 cP to about 200 cP, or in range from about 25 cP to about 90 cP, or in a range from about 25 cP to about 82 cP, or in a range from about 82 cP to about 200 cP. In yet another implementation, the viscosity of the photocurable printing composition is in a range from about 10 cP to about 1000 cP, or in a range from about 100 cP to about 800 cP, or in a range from about 200 cP to about 500 cP, or in a range from about 200 cP to about 300 cP. In each of the foregoing aspects, the viscosity may be determined according to ASTM D1084.

The photocurable printing composition may comprise, consist essentially of, or consist of at least one of: (1) one or more functional urethane acrylate oligomer components; (2) an acrylate monomer mixture including (2A) one or more monofunctional acrylate monomer components, and (2B) one or more multifunctional monomer components; (3) one or more photoinitiator components; and optionally (4) additional additives.

The photocurable printing composition includes one or more urethane acrylate or urethane diacrylate oligomer components (1). In one implementation, the one or more urethane acrylate oligomer components has long chain alkyl groups that form a controlled network structure to improve elongation and modulus of the cross-linked film. The one or more urethane acrylate oligomer components may be monofunctional or multifunctional (e.g, di-, tri-, tetra-, and higher functionality acrylates). The functionality of the urethane acrylate oligomer component may be three or less. The functionality of the urethane acrylate oligomer component may be two or less. In one implementation, the urethane acrylate oligomer component has a functionality that is greater than or equal to two.

In at least one implementation, the one or more urethane acrylate oligomer components contain more than two acrylate groups. Any suitable urethane acrylate oligomer component capable of achieving targeted properties in the final polishing article may be used. Examples of suitable urethane acrylate oligomer components include hydrophobic urethane acrylates, polybutadiene urethane acrylates, polyester urethane acrylates, polyester urethane methacrylates, polyether urethane acrylates, polyether urethane methacrylates, polycarbonate urethane acrylates, polytetrahydrofuran acrylates, polycaprolactone acrylates, silicone urethane acrylates, or combinations thereof.

Examples of suitable urethane acrylate oligomer components for forming the polishing pads described herein are depicted in Table I.

TABLE I

| | | Func- | | |
|---|---|---|---|---|
| Reference | | tion- | Polymer | Nominal |
| Name | Material Information | ality | Tg (° C.) | Viscosity (cP) |
| O1 | Aliphatic difunctional | 2 | | 20,000 at |
| | polyester urethane | | | 65° C. |
| | acrylate | | | |
| O2 | Aliphatic difunctional | 2 | −4 | 88,000 at |
| | polyester urethane | | | 60° C. |
| | acrylate | | | |
| O3 | Aliphatic difunctional | 2 | 8 | 46,000 at |
| | polyester urethane | | | 60° C. |
| | acrylate | | | |
| O4 | Aliphatic difunctional | 2 | 32 | 90,000 at |
| | polyester urethane | | | 25° C. |
| | acrylate | | | |
| O5 | Aliphatic difunctional | 2 | 45 | 4,200 at |
| | polyester urethane | | | 60° C. |
| | acrylate | | | |
| O6 | Aliphatic difunctional | 2 | 34 | 20,000 at |
| | polyester urethane | | | 60° C. |
| | acrylate | | | |
| O7 | Aliphatic difunctional | 2 | 41 | 20,000 at |
| | polyester urethane | | | 60° C. |
| | acrylate | | | |
| O8 | Aliphatic difunctional | 2 | 40 | 68,900 at |
| | polyester urethane | | | 25° C. |
| | acrylate | | | |
| O9 | Aliphatic urethane | 2 | 8 | 5,900 at |
| | acrylate | | | 60° C. |
| O10 | Methacrylate | 2 | 131 | 6,500 at |
| | terminated polyester | | | 50° C. |
| | oligomer | | | |

Examples of suitable urethane acrylate oligomer components include, but are not limited to, those under the designations of BOMAR® BR-743 urethane diacrylate, BOMAR® BR-7432 GB difunctional aliphatic polyester urethane diacrylate, BOMAR® BR-744BT difunctional aliphatic polyester urethane diacrylate, BOMAR® BRC-843 difunctional aliphatic hydrophobic urethane acrylate, BOMAR® BRC-843D difunctional aliphatic hydrophobic urethane acrylate, BOMAR® BRC-443 difunctional aliphatic hydrophobic urethane acrylate, BOMAR® BRC-443D difunctional aliphatic hydrophobic urethane acrylate, available from Bomar Corporation and CN996 available from Sartomer® Americas.

In at least one aspect, the weight average molecular weight of the urethane acrylate oligomer components is in a range from about 100 to about 50,000, or in a range from about 500 to about 20,000, or in a range from about 1,000 to about 10,000. In at least one aspect, the weight average molecular weight of the urethane acrylate component is 250 Daltons (Da) or greater, for example, a weight average molecular weight in a range from about 250 Da to about 6,000 Da, or in a range from about 500 Da to about 6,000 Da. The weight average molecular weight of the urethane acrylate oligomer components may be determined by gel permeation chromatography (GPC) in terms of polystyrene conversion. Not to be bound by theory but it is believed that practicing in this weight average molecular weight range provide excellent adhesive force and holding power, and is also capable of providing good coating workability.

In at least one implementation, the one or more urethane acrylate oligomer components include a reactive oligomer represented by chemical structure (A), which is a polyurethane acrylate, a material that may impart flexibility and elongation to the advanced polishing pad. An acrylate that contains urethane groups may be an aliphatic or an aromatic polyurethane acrylate, and the R or R′ groups shown in the structure may be aliphatic, aromatic, oligomeric, and may contain heteroatoms such as oxygen.

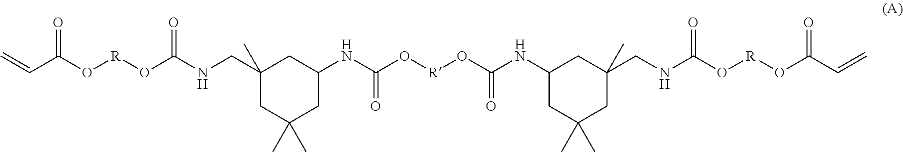

In at least one implementation, the one or more urethane acrylate oligomer components include an aliphatic polyester urethane (meth)acrylate having a functionality of 2, a nominal viscosity in a range from about 45,000 to about 90,000 cP at 60 degrees Celsius, or in a range from about 46,000 to about 88,000 cP at 60 degrees Celsius, and a Tg by DMA in a range from about −4 degrees Celsius to about 10 degrees Celsius, or in a range from about −4 degrees Celsius to about 8 degrees Celsius. In at least one example, the one or more urethane acrylate oligomer components include an aliphatic polyester urethane (meth)acrylate having a functionality of 2, a nominal viscosity of about 88,000 cP at 60 degrees Celsius and a Tg by DMA of about −4 degrees Celsius. In at least one example, the one or more urethane acrylate oligomer components include an aliphatic polyester urethane (meth)acrylate having a functionality of 2, a nominal viscosity in a range of about 88,000 cP at 60 degrees Celsius and a Tg by DMA of about −4 degrees Celsius.

In at least one implementation, the one or more urethane acrylate oligomer components include an aliphatic polyester urethane (meth)acrylate having a functionality of 2, a nominal viscosity in a range from about 60,000 to about 80,000 cP at 25 degrees Celsius, or in a range from about 65,000 to about 70,000 cP at 25 degrees Celsius, and a Tg by DMA in a range from about 30 degrees Celsius to about 45 degrees Celsius, or in a range from about 35 degrees Celsius to about 40 degrees Celsius. In at least one example, the one or more urethane acrylate oligomer components include an aliphatic polyester urethane (meth)acrylate having a functionality of 2, a nominal viscosity of about 68,900 cP at 25 degrees Celsius and a Tg by DMA of about 40 degrees Celsius.

In at least one implementation, the one or more urethane acrylate oligomer components include a hydrophobic urethane acrylate having a functionality of 2, a nominal viscosity in a range from about 19,000 to about 25,000 cP at 60 degrees Celsius, or in a range from about 20,000 to about 21,000 cP at 60 degrees Celsius, and a Tg by DMA in a range from about 30 degrees Celsius to about 45 degrees Celsius, or in a range from about 34 degrees Celsius to about 41 degrees Celsius. In at least one example, the one or more urethane acrylate oligomer components include a hydrophobic urethane acrylate having a functionality of 2, a nominal viscosity of about 20,000 cP at 60 degrees Celsius and a Tg by DMA of about 34 degrees Celsius. In at least one example, the one or more urethane acrylate oligomer components include a hydrophobic urethane acrylate having a functionality of 2, a nominal viscosity of about 20,000 cP at 60 degrees Celsius and a Tg by DMA of about 41 degrees Celsius

In at least one implementation, the one or more urethane acrylate oligomer components include a hydrophobic urethane acrylate having a functionality of 2, a nominal viscosity in a range from about 88,000 to about 94,000 cP at 25 degrees Celsius, or in a range from about 90,000 to about 91,000 cP at 25 degrees Celsius, and a Tg by DMA in a range from about 30 degrees Celsius to about 35 degrees Celsius, or in a range from about 30 degrees Celsius to about 32 degrees Celsius. In at least one example, the one or more urethane acrylate oligomer components include a hydrophobic urethane acrylate having a functionality of 2, a nominal viscosity of about 90,000 cP at 25 degrees Celsius and a Tg by DMA of about 32 degrees Celsius.

In at least one implementation, the one or more urethane acrylate oligomer components include a hydrophobic urethane acrylate having a functionality of 2, a nominal viscosity in a range from about 4,000 to about 5,000 cP at 60 degrees Celsius, or in a range from about 4,000 to about 4,200 cP at 60 degrees Celsius, and a Tg by DMA in a range from about 40 degrees Celsius to about 48 degrees Celsius, or in a range from about 45 degrees Celsius to about 48 degrees Celsius. In at least one example, the one or more urethane acrylate oligomer components include a hydrophobic urethane acrylate having a functionality of 2, a nominal viscosity of about 4,200 cP at 60 degrees Celsius and a Tg by DMA of about 45 degrees Celsius.

In at least one implementation, the one or more urethane acrylate oligomer components include a urethane acrylate oligomer having a functionality of 2, a nominal viscosity in a range from about 5,000 to about 6,000 cP at 60 degrees Celsius, or in a range from about 5,500 to about 5,900 cP at 60 degrees Celsius, and a Tg by DSC in a range from about 5 degrees Celsius to about 15 degrees Celsius, or in a range from about 8 degrees Celsius to about 10 degrees Celsius. In at least one example, the one or more urethane acrylate oligomer components include a urethane acrylate oligomer having a functionality of 2, a nominal viscosity of about 5,900 cP at 60 degrees Celsius and a Tg by DMA of about 8 degrees Celsius.

In at least one implementation, the urethane acrylate oligomer may be a semi-crystalline polyester-based urethane acrylate that is an ultraviolet (UV) curable oligomer synthesized by catalytic reaction of a difunctional polyol (or difunctional polythiol) and a difunctional isocyanate. The difunctional polyol may be, for example, a semi-crystalline polyester polyol. In particular for the synthesis, the catalytic reaction of a difunctional polyol (or difunctional polythiol) and a difunctional isocyanate may give a urethane oligomer as a prepolymer. The prepolymer is then capped by using acrylates to yield a urethane acrylate oligomer as the UV curable oligomer. The urethane formed from isocyanate groups may give toughness to the oligomer while the urethane formed from polyols may give flexibility. In one or more implementations, the present techniques may include selecting the difunctional polyol or difunctional polythiol to affect a property of a polishing layer of the polishing pad. The difunctional polyol may be, for example, a polyester polyol, polycarbonate polyol, poly(ester-ether) polyol, poly(carbonate-ester) polyol, or mixtures thereof. The polythiols may be corresponding structure with —SH group in place of the —OH group.

The chemical structure of polyols (e.g, semi-crystalline polyesters) or polythiols in the synthesis of the pre-polymer for the end-capped oligomer play a role in giving targeted properties of the oligomer and thus specific values of properties of the polishing layers. Two polyols with similar backbone chemistry but with different functional groups may lead to different properties of the oligomer and the polishing layers. Similarly, two polythiols with similar backbone chemistry but with different functional groups may lead to different properties of the oligomer and the polishing layers.

These oligomers formed with semi-crystalline polyester polyol (or corresponding polythiol) may possess high crystallinity and hence give good toughness to the material after photopolymerization. In one or more implementations, the urethane acrylate oligomers can be synthesized with targeted final properties. In particular implementations, the oligomer synthesis may be solvent-free at relatively low temperature and performed under inert atmosphere.

In at least one implementation, the urethane acrylate oligomer may be synthesized with a difunctional polyol or difunctional polythiol. Two examples of the difunctional polyol have the following structure:

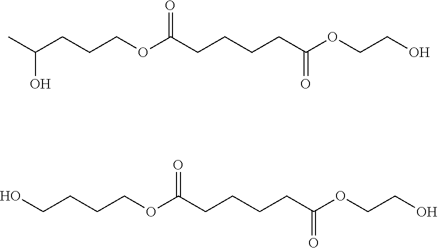 [SMILES: CC(O)CCCOC(=O)CCCCC(=O)OCCO ; O=C(CCCCC(=O)OCCCCO)OCCO]

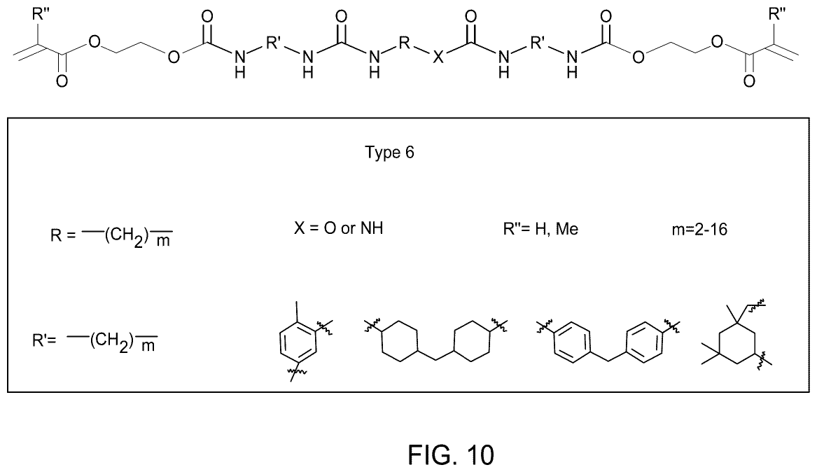

FIGS. 8-10 are diagrams of exemplary polyurethane acrylate oligomers that may be used with the formulations described in accordance with one or more implementations of the present disclosure. FIG. 8 is a General Structure A that may be at least three types: Type 1, Type 2, and Type 3. FIG. 9 is a General Structure B that may be at least two types: Type 4 and Type 5. FIG. 10 is a General Structure C that may be at least Type 6. The options for R′ groups of General Structure B are the same for R′ groups of General Structure A and General Structure C. In FIGS. 8-10, for two R groups in a Type structure, each R group in that given structure is different. Type 1 is meant for alkanediol and polyester diol. Type 2 is meant for alkanediol and polycarbonate diol.

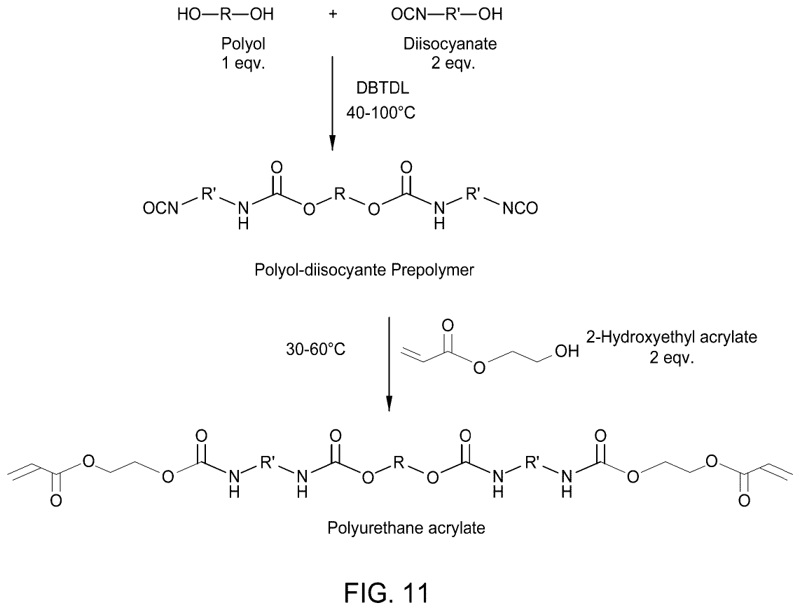

FIG. 11 is an exemplary synthesis of polyurethane acrylate oligomers that may be used with the formulations described in accordance with one or more implementations of the present disclosure. The synthesis starts with a polyol (1 mole equivalent) and a diisocyanate (2 mole equivalent). The catalyst dibutyltin dilaurate (DBTDL) is included and the mixture heated to a temperature in a range of 40 degrees Celsius to 100 degrees Celsius to provide the polyol-diisocyanate pre-polymer. Lastly, in this illustrated implementation, 2-hydroxyethyl acrylate (2 mole equivalent) is mixed with the pre-polymer at a temperature in the range of 40 degrees Celsius to 100 degrees Celsius to end-cap the pre-polymer at both ends with the acrylate to give the polyurethane acrylate oligomer.

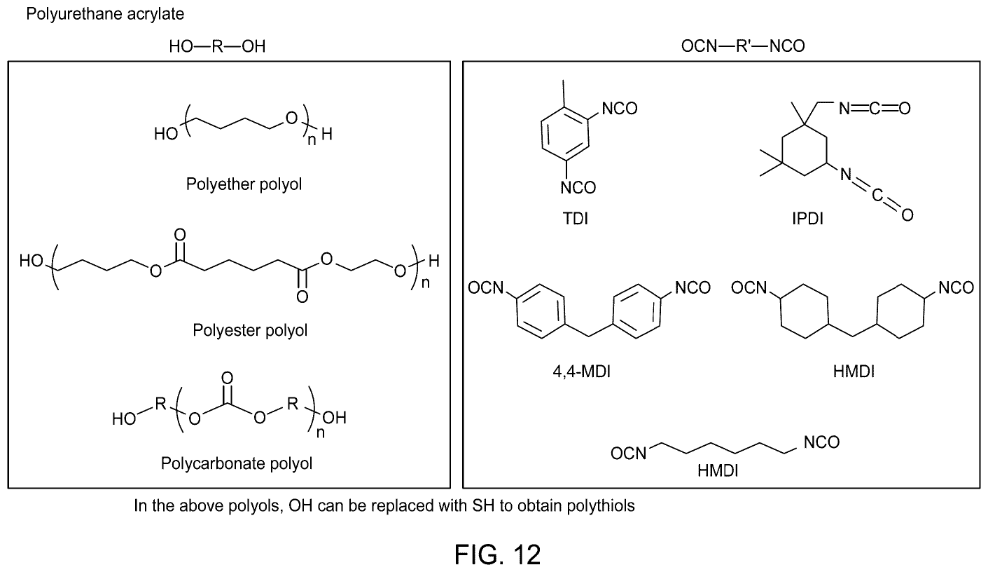

FIG. 12 is a diagram of examples of difunctional polyols/polythiols and difunctional isocyanates that may be utilized to form polyurethane acrylate oligomers that may be used with the formulations described in accordance with one or more implementations of the present disclosure. In these illustrated examples, the exemplary polyols include polyether polyol, polyester polyol, and polycarbonate polyol. The corresponding polythiols (not depicted) are as the depicted polyols but with the —OH group instead as a —SH group. The exemplary difunctional isocyanates (OCN—R′—NCO) are the structures labeled as TDI, IPDI, 4,4′-MDI, HMDI, and HDI, respectively.

The one or more urethane acrylate oligomer components may comprise at least 20 wt. %, 25 wt. %, 30 wt. %, 35 wt. %, 40 wt. %, 45 wt. %, 50 wt. %, 55 wt. %, or 60 wt. % based on the total weight of the pre-polymer composition. The one or more oligomer components may comprise up to 30 wt. %, 35 wt. %, 40 wt. %, 45 wt. %, 50 wt. %, 55 wt. %, 60 wt. %, or 65 wt. % based on the total weight of the pre-polymer composition. The amount of the oligomer component in the pre-polymer composition may be in a range from about 20 wt. % to about 65 wt. % based on the total weight of the pre-polymer composition, or in a range from about 20 wt. % to about 60 wt. %, or in a range from about 30 wt. % to about 60 wt. %, or in a range from about from about 30 wt. % to about 35 wt. %; or in a range from about 40 wt. % to about 45 wt. %; or in a range from about 60 wt. % to about 65 wt. %. Not to be bound by theory but it is believed that content lower than 25 wt. % tends to adversely affect properties of the printed polishing pad, for example, UTS and elongation, while a content higher than 65 wt. % tends to be very difficult to print.

In at least one implementation, in addition to the one or more urethane oligomer components, the photocurable printing composition may further comprise additional oligomers.

In at least one implementation, the additional oligomers include a methacrylate terminated polyester oligomer having a functionality of 2, a nominal viscosity in a range from about 6,000 to about 7,000 cP at 50 degrees Celsius, or in a range from about 6,500 to about 6,900 cP at 50 degrees Celsius, an approximate molecular weight in a range from about 500 Daltons to about 1,000 Daltons, or in a range from about 600 Daltons to about 700 Daltons, and a Tg by DSC in a range from about 5 degrees Celsius to about 15 degrees Celsius, or in a range from about 8 degrees Celsius to about 10 degrees Celsius. In at least one example, the additional oligomer component includes a methacrylate terminated polyester oligomer having a functionality of 2, a nominal viscosity of about 6,500 cP at 50 degrees Celsius, and approximate molecular weight of 665 Daltons, and a Tg by DMA of about 131 degrees Celsius. In at least one example, the additional oligomer component includes a methacrylate terminated polyester oligomer having a chemical formula of C40H56O8 and an approximate molecular weight of 664 Daltons.

In at least one implementation, the additional oligomers include a methacrylate terminated polyester oligomer having a functionality of 2, a nominal viscosity in a range from about 4,000 to about 6,000 cP at 40 degrees Celsius, or in a range from about 4,800 to about 5,200 cP at 40 degrees Celsius, or in a range from about 5,000 to about 5,100 cP at 40 degrees Celsius, an approximate molecular weight in a range from about 500 Daltons to about 1,000 Daltons, or in a range from about 600 Daltons to about 700 Daltons, or in a range from about 630 Daltons to about 650 Daltons, and a Tg by DMA in a range from about 160 degrees Celsius to about 190 degrees Celsius, or in a range from about 175 degrees Celsius to about 185 degrees Celsius. In at least one example, the additional oligomer component includes a methacrylate terminated polyester oligomer having a functionality of 2, a nominal viscosity of about 5,000 cP at 40 degrees Celsius, and approximate molecular weight of 645 Daltons, and a Tg by DMA of about 183 degrees Celsius. Methacrylate terminated polyester oligomers are commercially available from Designer Molecules, Inc, San Diego, CA under the trade names PEM-645 and PEAM-645.

The one or more additional oligomer components may comprise at least 1 wt. %, 2 wt. %, 3 wt. %, 4 wt. %, 5 wt. %, 6 wt. %, 7 wt. %, 8 wt. %, 9 wt. %, or 10 wt. % based on the total weight of the pre-polymer composition. The one or more oligomer components may comprise up to 2 wt. %, 3 wt. %, 4 wt. %, 5 wt. %, 6 wt. %, 7 wt. %, 8 wt. %, 9 wt. %, 10 wt. %, or 15 wt. % based on the total weight of the pre-polymer composition. The amount of the oligomer component in the pre-polymer composition may be in a range from about 1 wt. % to about 15 wt. % based on the total weight of the pre-polymer composition, or in a range from about 1 wt. % to about 10 wt. %, or in a range from about from about 1 wt. % to about 5 wt. %; or in a range from about 1 wt. % to about 3 wt. %; or in a range from about 1 wt. % to about 2 wt. %.

The photocurable printing composition further includes (2) an acrylate monomer mixture. The acrylate monomer mixture includes (2A) one or more monofunctional acrylate monomer components, and (2B) one or more multifunctional monomer components.

The acrylate monomer mixture may comprise at least 40 wt. %, 45 wt. %, 50 wt. %, 55 wt. %, 60 wt. %, 65 wt. %, 70 wt. %, or 75 wt. % based on the total weight of the pre-polymer composition. The acrylate monomer mixture may comprise up to 45 wt. %, 50 wt. %, 55 wt. %, 60 wt. %, 65 wt. %, 70 wt. %, 75 wt. % or 80 wt. % based on the total weight of the pre-polymer composition. The amount of the oligomer component in the pre-polymer composition may be in a range from about 40 wt. % to about 80 wt. % based on the total weight of the pre-polymer composition, or in a range from about 40 wt. % to about 75 wt. %, or in a range from about 50 wt. % to about 75 wt. %, or in a range from about from about 60 wt. % to about 80 wt. %; or in a range from about 60 wt. % to about 75 wt. %; or in a range from about 70 wt. % to about 80 wt. %. Not to be bound by theory but it is believed that content lower than 40 wt. % tends to adversely affect properties of the printed polishing pad, for example, UTS and elongation, while a content higher than 80 wt. % tends to be very difficult to print.

The photocurable printing composition further includes one or more monofunctional acrylate monomer components (2A). In at least one implementation, the monofunctional acrylate monomer components include high Tg monomers such as high Tg monofunctional acrylates. Examples of suitable monofunctional acrylate monomer components include isobornyl acrylate (IBXA), 3,3,5-Trimethylcyclohexyl acrylate (TMCHA), diethyl acrylamide isobornyl methacrylate, diethyl methacrylamide, N,N-Diethyl acrylamide (DEAA), N-Vinyl-2-Pyrrolidone (NVP), 4-tert-Butylcyclohexyl acrylate (TBCHA), cyclohexyl acrylate (CHA), tetrahydrofurfuryl acrylate (THFA), 2-(2-Vinyloxyethoxy)ethyl acrylate (VEEA), or combinations thereof.

In at least one implementation, the photocurable printing composition includes IBXA. IBXA is a monofunctional acrylate. The term “functionality” may refer to the number of reactive or cross-linkable functional groups per molecule. IBXA may have a purity of about 95% or more, such as about 99% or more, such as about 99.5% or more. IBXA contains less alcohol content (e.g, isobornyl alcohol) compared to lower purity isobornyl acrylate (which may be referred to as “IBOA”). IBOA may have a purity of about 91% to about 92%. The alcohol component can act as a plasticizer leading to lower Tg and storage modulus values for the pad materials. Therefore, the lower alcohol content of IBXA increases Tg and storage modulus values compared to conventional pad materials. The term “plasticizer” may refer to a neutral material that does not participate in the cross-linking process.

IBXA may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, or 80 wt. % based on the total weight of the pre-polymer composition. IBXA may comprise up to 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, or 85 wt. % based on the total weight of the pre-polymer composition. The amount of IBXA in the photocurable printing composition may be in a range from about 10 wt. % to about 85 wt. % based on the total weight of the photopolymerizable compounds, or in a range from about 10 wt. % to about 20 wt. %, or in a range from about 20 wt. % to about 70 wt. %, or in a range from about 20 wt. % to about 50 wt. %, or in a range from about 20 wt. % to about 40 wt. %, or in a range from about from about 20 wt. % to about 35 wt. %; or in a range from about 20 wt. % to about 30 wt. %; or in a range from about 40 wt. % to about 50 wt. %. Not to be bound by theory but it is believed that an IBXA content lower than 20 wt. % tends to adversely affect thermal properties of the printed pad, while a content higher than 50 wt. % tends to adversely affect the elasticity.

In at least one implementation, the photocurable printing composition includes IBOA. IBOA may comprise at least 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, or 80 wt. % based on the total weight of the pre-polymer composition. IBOA may comprise up to 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, or 85 wt. % based on the total weight of the pre-polymer composition. The amount of IBOA in the photocurable printing composition may be in a range from about 10 wt. % to about 85 wt. % based on the total weight of the pre-polymer composition, or in a range from about 10 wt. % to about 20 wt. %, or in a range from about 20 wt. % to about 70 wt. %, or in a range from about 20 wt. % to about 50 wt. %, or in a range from about 20 wt. % to about 40 wt. %, or in a range from about from about 20 wt. % to about 35 wt. %; or in a range from about 20 wt. % to about 30 wt. %; or in a range from about 40 wt. % to about 50 wt. %. Not to be bound by theory but it is believed that an IBOA content lower than 10 wt. % tends to adversely affect thermal properties of the printed pad, while a content higher than 85 wt. % tends to adversely affect the elasticity.

In at least one implementation, the photocurable printing composition includes 3,3,5-Trimethylcyclohexyl acrylate (TMCHA). TMCHA is a monofunctional acrylate. TMCHA may comprise at least 5 wt. %, 10 wt. %, 15 wt. %, 20 wt. %, 25 wt. %, 30 wt. %, 35 wt. %, 40 wt. %, or 45 wt. % based on the total weight of the pre-polymer composition. The one or more oligomer components may comprise up to 10 wt. %, 15 wt. %, 20 wt. %, 25 wt. %, 30 wt. %, 35 wt. %, 40 wt. %, 45 wt. %, or 50 wt. % based on the total weight of the pre-polymer composition. The amount of TMCHA in the photocurable printing composition may be in a range from about 5 wt. % to about 50 wt. % based on the total weight of the pre-polymer composition, or in a range from about 10 wt. % to about 30 wt. %, or in a range from about 10 wt. % to about 20 wt. %; or in a range from about 10 wt. % to about 15 wt. %, or in a range from about 30 wt. % to about 40 wt. %. Not to be bound by theory but it is believed that a TMCHA content lower than 5 wt. % tends to limit the amount of oligomer in the mixture, while a content higher than 50 wt. % may lead to incompatibility issues in some mixtures.

In at least one implementation, the photocurable printing composition includes N, N-Diethyl acrylamide (DEAA). DEAA is a monofunctional acrylate.

DEAA may comprise at least 1 wt. %, 2 wt. %, 4 wt. %, 5 wt. %, 7 wt. %, 8 wt. %, 10 wt. %, 12 wt. %, 14 wt. %, 15 wt. %, 17 wt. %, or 18 wt. % based on the total weight of the pre-polymer composition. DEAA may comprise up to 2 wt. %, 4 wt. %, 5 wt. %, 7 wt. %, 8 wt. %, 10 wt. %, 12 wt. %, 14 wt. %, 15 wt. %, 17 wt. %, 18 wt. %, or 20 wt. % based on the total weight of the pre-polymer composition. The amount of DEAA in the photocurable printing composition may be in a range from about 1 wt. % to about 20 wt. % based on the total weight of the pre-polymer composition, or in a range from about 1 wt. % to about 15 wt. %, or in a range from about 1 wt. % to about 10 wt. %, or in a range from about 2 wt. % to about 8 wt. %, or in a range from about 4 wt. % to about 8 wt. %; or in a range from about 4 wt. % to about 6 wt. %. Not to be bound by theory but it is believed that a DEAA content lower than 1 wt. % tends to be difficult to print, while a content higher than 10 wt. % tends to impart excessive hydrophilicity in the material.

In at least one implementation, the photocurable printing composition includes NVP. NVP is a monofunctional acrylate consisting of a 5-membered lactam ring linked to a vinyl group. NVP may function as a reactive diluent that increases polymerization rate and acrylate conversion rate. NVP may comprise at least 1 wt. %, 2 wt. %, 4 wt. %, 5 wt. %, 7 wt. %, 8 wt. %, 10 wt. %, 12 wt. %, 14 wt. %, 15 wt. %, 17 wt. %, or 18 wt. % based on the total weight of the pre-polymer composition. NVP may comprise up to 2 wt. %, 4 wt. %, 5 wt. %, 7 wt. %, 8 wt. %, 10 wt. %, 12 wt. %, 14 wt. %, 15 wt. %, 17 wt. %, 18 wt. %, or 20 wt. % based on the total weight of the pre-polymer composition. The amount of NVP in the photocurable printing composition may be in a range from about 1 wt. % to about 20 wt. % based on the total weight of the pre-polymer composition, or in a range from about 1 wt. % to about 15 wt. %, or in a range from about 1 wt. % to about 10 wt. %, or in a range from about 2 wt. % to about 8 wt. %, or in a range from about 4 wt. % to about 8 wt. %; or in a range from about 5 wt. % to about 7 wt. %.

The one or more monofunctional acrylate monomer components (2A) may comprise at least 40 wt. %, 45 wt. %, 50 wt. %, 55 wt. %, 60 wt. %, 65 wt. %, or 70 wt. % based on the total weight of the pre-polymer composition. The one or more monofunctional acrylate monomer components (2A) may comprise up to 45 wt. %, 50 wt. %, 55 wt. %, 60 wt. %, 70 wt. %, or 75 wt. % based on the total weight of the pre-polymer composition. The amount of the one or more monofunctional acrylate monomer components (2A) in the pre-polymer composition may be in a range from about 40 wt. % to about 75 wt. % based on the total weight of the pre-polymer composition, or in a range from about 50 wt. % to about 70 wt. %, or in a range from about from about 50 wt. % to about 65 wt. %; or in a range from about 50 wt. % to about 60 wt. %; or in a range from about 50 wt. % to about 55 wt. %.

The photocurable printing composition further includes one or more multifunctional acrylate monomer or multifunctional oligomer components (2B). The one or more multifunctional acrylate monomer or multifunctional oligomer components may include crosslinkers and reactive diluents. In at least one implementation, one or more multifunctional acrylate monomer or multifunctional oligomer components has a glass transition temperature of 10 degrees Celsius or lower and/or a molecular weight of 300 g/mol or less. In at least one implementation, the one or more multifunctional acrylate monomer or multifunctional oligomer components include trifunctional or higher functional monomers such as trimethylolpropane triacrylate (“TMPTA”), ethoxylated TMPTA, 1,6-hexanediol diacrylate (“HDDA”), tricyclodecane dimethanol diacrylate (“TCDDA”), polyether tetraacrylate, pentaerythritol triacrylate, pentaerythritol tetraacrylate, dipentaerythritol hexaacrylate, di(trimethylolpropane) tetraacrylate, glyceryl propoxy triacrylate, caprolactone-modified trimethylolpropane triacrylate, pentaerythritol ethoxy tetraacrylate, and caprolactam modified dipentaerythritol hexaacrylate, and oligomers thereof.

In at least one implementation, the one or more multifunctional acrylate monomer or multifunctional oligomer components include TMPTA. TMPTA is commercially available from the Sartomer Company under the trade name SR-351H.

TMPTA may comprise at least 0.1 wt. %, 1 wt. %, 2 wt. %, 4 wt. %, 5 wt. %, 7 wt. %, 8 wt. %, 10 wt. %, 12 wt. %, 13, wt. %, or 14 wt. % based on the total weight of the pre-polymer composition. TMPTA may comprise up to 1 wt. %, 2 wt. %, 4 wt. %, 5 wt. %, 7 wt. %, 8 wt. %, 10 wt. %, 12 wt. %, 13, wt. %, 14 wt. %, or 15 wt. % based on the total weight of the pre-polymer composition. The amount of TMPTA in the photocurable printing composition may be in a range from about 1 wt. % to about 10 wt. % based on the total weight of the pre-polymer composition, or in a range from about 1 wt. % to about 5 wt. %, or in a range from about 1 wt. % to about 4 wt. %; or in a range from about 1 wt. % to about 3 wt. %. Not to be bound by theory but it is believed that a TMPTA content lower than 0.1 wt. % does not provide any benefit to E′90, while a content higher than 15 wt. % tends to provide a brittle end product.

In at least one implementation, the photocurable printing composition includes HDDA. HDDA is a difunctional acrylate ester monomer. HDDA may comprise at least 1 wt. %, 2 wt. %, 4 wt. %, 5 wt. %, 7 wt. %, 8 wt. %, 10 wt. %, 12 wt. %, 14 wt. %, or 15 wt. % based on the total weight of the pre-polymer composition. HDDA may comprise up to 2 wt. %, 4 wt. %, 5 wt. %, 7 wt. %, 8 wt. %, 10 wt. %, 12 wt. %, 14 wt. %, 15 wt. %, or 17 wt. % based on the total weight of the pre-polymer composition. The amount of HDDA in the photocurable printing composition may be in a range from about 1 wt. % to about 17 wt. % based on the total weight of the pre-polymer composition, or in a range from about 1 wt. % to about 15 wt. %, or in a range from about 1 wt. % to about 10 wt. %, or in a range from about 2 wt. % to about 8 wt. %, or in a range from about 4 wt. % to about 8 wt. %; or in a range from about 5 wt. % to about 7 wt. %.

The one or more multifunctional acrylate monomer components (2B) may comprise at least 1 wt. %, 2 wt. %, 5 wt. %, 7 wt. %, 10 wt. %, 12 wt. %, 15 wt. %, 17 wt. %, or 20 wt. % based on the total weight of the pre-polymer composition. The one or more multifunctional acrylate monomer components (3) may comprise up to 2 wt. %, 5 wt. %, 7 wt. %, 10 wt. %, 12 wt. %, 15 wt. %, 17 wt. %, 20 wt. % or 25 wt. % based on the total weight of the pre-polymer composition. The amount of the one or more multifunctional acrylate monomer components (3) in the pre-polymer composition may be in a range from about 1 wt. % to about 25 wt. % based on the total weight of the pre-polymer composition, or in a range from about 1 wt. % to about 20 wt. %, or in a range from about from about 1 wt. % to about 10 wt. %; or in a range from about 1 wt. % to about 5 wt. %; or in a range from about 5 wt. % to about 15 wt. %.

The photocurable printing composition further includes one or more photoinitiator components (4). In the radiation curing process, the photoinitiator component initiates the curing in response to incident radiation. The selection of the type of the photoinitiator component in the resin precursor composition is generally dependent on the wavelength of curing radiation employed in curing the resin precursor composition. Typically, the peak absorption wavelengths of the selected photoinitiator vary with the range of wavelength of curing radiation to effectively utilize radiation energy, especially using ultraviolet light as radiation.

Examples of suitable photoinitiators used to form one or more of the at least two different pre-polymer compositions include polymeric photoinitiators and/or oligomer photoinitiators, such as benzoin ethers, benzyl ketals, acetyl phenomes, alkyl phenomes, phosphine oxides, benzophenone compounds and thioxanthone compounds that include an amine synergist, or combinations thereof. In some examples, photoinitiators may include Irgacure® series products, such as Irgacure® 819, manufactured by BASF of Ludwigshafen, Germany.

The photoinitiator component in the resin precursor composition may comprise at least 0.1 wt. %, 0.5 wt. %, 1 wt. %, 2 wt. %, 3 wt. %, or 4 wt. % based on the total weight of the pre-polymer composition. The photoinitiator component may comprise up to 0.5 wt. %, 1 wt. %, 2 wt. %, 3 wt. %, 4 wt. %, or 5 wt. % based on the total weight of the pre-polymer composition. The amount of photoinitiator component in the resin precursor composition may be from about 0.1 wt. % to about 5 wt. % relative to the total weight of the pre-polymer composition, or from about 0.5 wt. % to about 4 wt. %; or from about 0.5 wt. % to about 2.5 wt. %, or from about 0.5 wt. % to about 1.0 wt. %; or from about 1.0 wt. % to about 1.5 wt. %; or from about 1.5 wt. % to about 2.0 wt. %.

The photocurable printing composition may further include additional additives. Additional additives may include, for example, one or more emulsifiers/surfactants, inorganic particles, organic particles or both, one or more porosity forming agents, one or more stabilizers (e.g, butylated hydroxytoluene “BHT”), antioxidants, inhibitors (e.g. MEHq stabilizer for free radical cure), leveling agents, and sacrificial materials.

The photocurable printing composition may further comprise one or more emulsifiers/surfactants. The one or more emulsifiers are selected from an anionic surfactant, a cationic surfactant, a nonionic surfactant, an amphoteric or a combination thereof. As used herein, “emulsifier” refers to any compound or substance that enables the formation of an emulsion. The emulsifier may be selected from any surface-active compound or polymer capable of stabilizing emulsions, providing the emulsifier contains at least one anionic, cationic, amphoteric or nonionic surfactant and is used in sufficient quantities to provide the resin precursor composition with a porosity-forming agent-in-liquid polymer emulsion. Typically, such surface-active compounds or polymers stabilize emulsions by preventing coalescence of the dispersed amounts of porosity-forming agent within the emulsion. The surface-active compounds useful as emulsifiers in the present resin precursor composition are anionic, cationic, amphoteric or nonionic surfactant or combination of surfactants. Mixtures of surfactants of different types and/or different surfactants of the same type can be used. In one implementation, the surfactant is a polysiloxane-based surfactant.

The photocurable printing composition may further comprise inorganic particles, organic particles or both. Because the 3D printing process involves layer-by-layer sequential deposition of at least one composition per layer, it may also be appropriate to additionally deposit inorganic or organic particles disposed upon or within a pad layer to obtain a certain pad property and/or to perform a certain function. The inorganic or organic particles may be in the 50 nanometer (nm) to 100 micrometer (μm) range in size and may be added to the precursor materials prior to being dispensed by the additive manufacturing system 600 or added to an uncured printed layer in a ratio of between 1 and 50 wt. %. The inorganic or organic particles may be added to during the advanced polishing pad formation process to improve the ultimate tensile strength, improve yield strength, improve the stability of the storage modulus over a temperature range, improve heat transfer, adjust a surfaces zeta potential, and adjust a surface's surface energy.

The particle type, chemical composition, or size, and the added particles may vary by application or targeted effect that is to be achieved. The inorganic or organic particles may be in the 25 nanometer (nm) to 100 micrometer (μm) range in size and may be added to the precursor materials prior to being dispensed by the droplet ejecting printer or added to an uncured printed layer in a ratio of between 1 and about 50 wt. %. In some implementations, the particles may include intermetallics, ceramics, metals, polymers and/or metal oxides, such as ceria, alumina, silica, zirconia, zinc oxides, zinc sulfides, nitrides, carbides, or a combination thereof. In one example, the inorganic or organic particles disposed upon or within a pad may include particles of high performance polymers, such PEEK, PEK, PPS, and other similar materials to improve the thermal conductivity and/or other mechanical properties of the advanced polishing pad.

The photocurable printing composition may further comprise one or more sacrificial material composition(s). The sacrificial material compositions, which may be used to form the pore-features described above, include water, glycols (e.g, polyethylene glycols), glycol-ethers, amines, or combinations thereof. Examples of suitable sacrificial material precursors which may be used to form the pore forming features described herein include ethylene glycol, butanediol, dimer diol, propylene glycol-(1,2) and propylene glycol-(1,3), octane-1,8-diol, neopentyl glycol, cyclohexane dimethanol (1,4-bis-hydroxymethylcyclohexane), 2-methyl-1,3-propane diol, glycerin, trimethylolpropane, hexanediol-(1,6), hexanetriol-(1,2,6) butane triol-(1,2,4), trimethylolethane, pentaerythritol, quinitol, mannitol and sorbitol, methylglycoside, also diethylene glycol, triethylene glycol, tetraethylene glycol, polyethylene glycols, dibutylene glycol, polybutylene glycols, ethylene glycol, ethylene glycol monobutyl ether (EGMBE), diethylene glycol monoethyl ether, ethanolamine, diethanolamine (DEA), triethanolamine (TEA), and combinations thereof.

In some implementations, the sacrificial material precursor includes a water soluble polymer, such as 1-vinyl-2-pyrrolidone, vinylimidazole, polyethylene glycol diacrylate, acrylic acid, sodium styrenesulfonate, Hitenol BC10®, Maxemul 6106® hydroxyethyl acrylate and [2-(methacryloyloxy)ethyltrimethylammonium chloride, 3-allyloxy-2-hydroxy-1-propanesulfonic acid sodium, sodium 4-vinylbenzenesulfonate, [2-(methacryloyloxy)ethyl]dimethyl-(3-sulfopropyl)ammonium hydroxide, 2-acrylamido-2-methyl-1-propanesulfonic acid, vinylphosphonic acid, allyltriphenylphosphonium chloride, (vinylbenzyl)trimethylammonium chloride, E-SPERSE RS-1618, E-SPERSE RS-1596, methoxy polyethylene glycol monoacrylate, methoxy polyethylene glycol diacrylate, methoxy polyethylene glycol triacrylate, or combinations thereof.

Advantages of the implementations described herein are further illustrated by the following examples. The particular materials and amounts thereof, as well as other conditions and details, recited in these examples should not be used to limit the implementations described herein. Examples of the present disclosure are identified by the letter “E” followed by the sample number while comparative examples, which are not examples of the present disclosure are designated by the letter “X” followed by the sample number.

As noted above, in some implementations, one or more of the materials that are used to form at least one of the polishing elements, such as the polishing elements 304, the foundation layer 302, or both, is formed by sequentially depositing and post deposition processing of at least one curable resin precursor composition. In at least one implementation, the pre-polymer compositions are mixed during the precursor formulation process performed in the additive manufacturing system 600, will include the formulation of pre-polymer compositions that contain functional oligomers, monofunctional acrylate monomers, multifunctional acrylate monomers, and curing components, such as photoinitiators. Examples of some of these components are listed in Table I.

### Examples

The following non-limiting examples are provided to further illustrate implementations described herein. However, the examples are not intended to be all-inclusive and are not intended to limit the scope of the implementations described herein. The particular materials and amounts thereof, as well as other conditions and details, recited in these examples should not be used to limit the implementations described herein.

Examples of a functional oligomer can be found in item O1, O2, O3, and O4 in Table 1. Examples of functional reactive diluents and other additives can be found in items M1-M6 in Table 1. An example of a curing component is found in item P1 in Table II and is available from Ciba Specialty Chemicals Inc. and RAHN USA Corporation.

TABLE II

| | | Func- | Polymer | | |
|---|---|---|---|---|---|
| Reference | | tion- | Tg | Viscosity | MW |
| Name | Material Information | ality | (° C.) | (cP) | (Da) |
| O1 | Aliphatic polyester | 2 | | 20,000 at | |
| | urethane diacrylate | | | 65° C. | |
| O2 | Aliphatic polyester | 2 | 40 | 6700 | |
| | urethane diacrylate | | | | |
| O9 | Aliphatic urethane | 2 | 8 | 5900 at | |
| | acrylate | | | 60° C. | |
| O10 | Methacrylate terminated | 2 | 131 | 6500 at | 665 |
| | polyester oligomer | | | 50° C. | |
| M1 | Isobornyl Acrylate | 1 | 97 | 10.7 at | 208 |
| | | | | 25° C. | |
| M2 | Trimethylolpropane | 3 | 32 | 106 at | 296 |
| | Triacrylate (TMPTA) | | | 25° C. | |
| M3 | 3,3,5- | 1 | 27 | 1-10 at | 196 |
| | Trimethylcyclohexyl | | | 25° C. | |
| | acrylate (TMCHA) | | | | |
| M4 | N,N-Diethyl acrylamide | 1 | 81 | 1.7 at | 127 |
| | DEAA ™ | | | 25° C. | |
| M5 | 1,6-Hexanediol | 2 | | 5-15 at | 226 |
| | diacrylate (HDDA) | | | 25° C. | |
| M6 | N-Vinyl-2-Pyrrolidone | 1 | | 2.4 at | 111 |
| | | | | 20° C. | |
| P1 | 2-Hydroxy-2-methyl-1- | | | | |
| | phenyl-propan-1-one | | | | |

Examples of formulations for forming the advanced polishing pads described herein are illustrated below in Table III.

TABLE III

| | Material Information | Formulation | Viscosity | | UTS |
|---|---|---|---|---|---|
| Item No. | (See Table 1 Ref. Name) | Composition | (cP, 70° C.) | % EL | (MPa) |
| X1 | M1:M2:M3:M4:P1 | 57:5:27:10:2 | 0 | 1.7 | 38 |
| E1 | O1:M1:M2:M3:M4:P1 | 21:44:4:21:8:2 | 13 | 20 | 29 |
| E2 | O1:M1:M2:M3:M4:P1 | 29:39:3:19:7:2 | 25 | 44 | 22 |
| E3 | O1:M1:M2:M3:M4:P1 | 44:30:3:15:6:2 | 82 | 79 | 18 |
| E4 | O1:M1:M2:M3:M4:P1 | 46:30:3:14:5:2 | 98 | 81 | 19 |
| E5 | O1:M1:M2:M3:M4:P1 | 59:22:2:11:4:2 | ~200 | 85 | 13 |
| E6 | O1:M1:M2:M3:M5:M6:P1 | 34:9:3:35:10:7:2 | 30.15 | 29 | 27.5 |
| E7 | O1:M1:M2:M3:M5:M6:P1 | 34:13:3:35:6:7:2 | 31.33 | 40 | 27 |
| E8 | O1:M1:M2:M3:M5:M6:P1 | 34:13:4:36:4:7:2 | 32.96 | 31 | 25 |
| E9 | O1:M1:M2:M3:M5:M6:P1 | 33:14:3:35:6:7:2 | 27.78 | 36 | 27 |
| E10 | O2:M2:M3:M5:M6:P1 | 38:3:40:10:7:2 | 30.15 | 30 | 30 |
| E11 | O2:M1:M2:M3:M5:M6:P1 | 37:4:3:41:6:7:2 | 30.74 | 48 | 29 |
| E12 | O2:M1:M2:M3:M6:P1 | 37:8.6:5:41:7.3:2 | Unstable | 56 | 27 |
| E13 | O2:M1:M2:M3:M5:M6:P1 | 36:13:3:35:4:7:2 | 32.36 | 33 | 27 |
| E14 | O2:M1:M2:M3:M5:M6:P1 | 35:21:3:28:4:7:2 | 30.29 | 29 | 26 |
| E15 | O2:M2:M3:M5:M6:P1 | 29:2:50:10:7:2 | Unstable | 19 | 29 |
| E16 | O9:M1:M2:M3:M4:P1 | 29:40.6:3.5:19.5:7.4:2 | 14 | 7 | 42 |
| E17 | O9:M1:M2:M3:M4:P1 | 41.38:33.53:2.9:16.1:6.1:2 | 28.67 | 15 | 40 |
| E18 | O9:M1:M2:M3:M6:P1 | 45:10:3:33.0:7:2 | 35.07 | 66 | 36 |
| E19 | O9:M1:M2:M3:M6:P1 | 45:11.5:1.5:33.0:7:2 | 35.17 | 80 | 41 |
| E20 | O9:M1:M2:M3:M6:P1 | 43:22:2:24.0:7:2 | 33.55 | 70 | 43 |
| E21 | O9:O10:M1:M2:M3:M6:P1 | 42:3:22:2:23.0:7:2 | 33.25 | 37 | 41 |
| E22 | O9:O10:M1:M2:M3:M6:P1 | 41:2:34:1:13.0:7:2 | 35.32 | 58 | 44 |
| E23 | O1:M1:M2:M3:M4:M5:P1 | 46:27:3:12:5:5:2 | 99.36 | 50 | 19 |
| E24 | O1:M1:M2:M3:M4:M5:P1 | 46:25:3:9:5:10:2 | | 30 | 17 |

Table IV depicts the results for the formulations depicted in Table III. Table IV depicts the mechanical performance of the cross-linked films of the formulations disclosed in Table III. Samples were cast in a silicon mold and were characterized as per ASTM D638—the standard test method for tensile properties of plastics. All samples were exposed to approximately 1150 mJ/cm2 of UV dose using an H-bulb. The samples had a thickness between 2.5 and 2.8 mm.

TABLE IV

| Item | E′30 | E′90 | | Max | UTS | | Young's |
|---|---|---|---|---|---|---|---|
| No. | (MPa) | (MPa) | Tan D | Tan D | (MPa) | % EL | Modulus |
| X1 | 1306 | 713 | 1.27 | 113 | 38 | 1.7 | 2690 |
| E1 | 967 | 343 | 0.93 | 110 | 29 | 20 | 1000 |
| E2 | 573 | 182 | 0.76 | 114 | 22 | 44 | 881 |
| E3 | 476 | 85 | 0.53 | 112 | 18 | 79 | 427 |
| E4 | 478 | 81 | 0.51 | 111 | 19 | 81 | 517 |
| E5 | 390 | 21 | 0.35 | 88 | 13 | 85 | 158 |
| E6 | 744 | 158 | 0.41 | 108 | 27.5 | 29 | 900 |
| E7 | 844 | 154 | 0.5 | 106 | 27 | 40 | 950 |
| E8 | 800 | 147 | 0.52 | 109 | 25 | 31 | 800 |
| E9 | 721 | 146 | 0.53 | 109 | 27 | 36 | 940 |
| E10 | 902 | 261 | 0.53 | 109 | 30 | 30 | 980 |
| E11 | 794 | 196 | 0.66 | 106 | 29 | 48 | 975 |
| E12 | 864 | 296 | 0.75 | 110 | 27 | 56 | 920 |
| E13 | 813 | 259 | 0.72 | 109 | 27 | 33 | 940 |
| E14 | 786 | 314 | 0.71 | 113 | 26 | 29 | 928 |
| E15 | 866 | 181 | 0.68 | 100 | 29 | 19 | 1200 |
| E16 | 1721 | 75 | 1.03 | 92 | 42 | 7 | 1930 |
| E17 | 1497 | 13 | 0.94 | 80 | 40 | 15 | 1800 |
| E18 | 1290 | 12 | 0.85 | 79 | 36 | 66 | 1850 |
| E19 | 1140 | 7 | 1 | 75 | 41 | 80 | 1750 |
| E20 | 1485 | 10 | 0.96 | 79 | 43 | 70 | 2000 |
| E21 | 1412 | 22 | 0.96 | 85 | 41 | 37 | 2050 |
| E22 | 1546 | 28 | 1.06 | 88 | 44 | 58 | 2000 |
| E23 | 381 | 49 | 0.43 | 100 | 19 | 50 | 472 |
| E24 | 405 | 74 | 0.36 | 102 | 17 | 30 | 467 |

In the Summary and in the Detailed Description, and the Claims, and in the accompanying drawings, reference is made to particular features (including method operations) of the present disclosure. It is to be understood that the disclosure in this specification includes all possible combinations of such particular features. For example, where a particular feature is disclosed in the context of a particular aspect, implementation, or example of the present disclosure, or a particular claim, that feature can also be used, to the extent possible in combination with and/or in the context of other particular aspects and implementations of the present disclosure, and in the present disclosure generally.

The term “comprises” and grammatical equivalents thereof are used herein to mean that other components, ingredients, operations, etc. are optionally present. For example, an article “comprising” (or “which comprises”) components A, B, and C can consist of (i.e, contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

When introducing elements of the present disclosure or exemplary aspects or implementation(s) thereof, the articles “a,” “an,” “the” and “said” are intended to mean that there are one or more of the elements.

While the foregoing is directed to implementations of the present disclosure, other and further implementations of the disclosure may be devised without departing from the basic scope thereof, and the scope thereof is determined by the claims that follow.

1. A photocurable printing composition, the photocurable printing composition, comprising:
a urethane acrylate oligomer having a functionality of 2 or more, a nominal viscosity greater than 250 cP at 25 degrees Celsius, and a glass transition temperature (Tg) of −4 degrees Celsius or greater, the urethane acrylate oligomer present from about 20% to about 60% by weight based on a total weight of the photocurable printing composition;
an acrylate monomer mixture, comprising:
one or more monofunctional monomers selected from isobornyl acrylate, 3,3,5-Trimethylcyclohexyl acrylate (TMCHA), N-Vinyl-2-Pyrrolidone, N,N-Diethyl acrylamide (DEAA) or a combination thereof; and
one or more multifunctional monomers selected from a trifunctional acrylate ester monomer, 1,6-Hexanediol diacrylate, or a combination thereof, wherein the acrylate monomer mixture is present from 40% to 80% by weight based on a total weight of the photocurable printing composition and the photocurable printing composition has a viscosity of 20 centipoise or higher at 70 degrees Celsius; and
a photoinitiator.

2. The photocurable printing composition of claim 1, wherein the photocurable printing composition has a viscosity in a range from about 25 centipoise to about 200 centipoise at 70 degrees Celsius.

3. The photocurable printing composition of claim 1, wherein the urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius.

4. The photocurable printing composition of claim 1, wherein the urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius.

5. The photocurable printing composition of claim 1, wherein the urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius.

6. The photocurable printing composition of claim 1, wherein the urethane acrylate oligomer has a functionality of 2, a nominal viscosity in a range from about 4,000 to about 5,000 cP at 60 degrees Celsius, and a Tg by DMA in a range from about 40 degrees Celsius to about 48 degrees Celsius.

7. The photocurable printing composition of claim 1, wherein the urethane acrylate oligomer is present from about 30% to 60% by weight based on a total weight of the photocurable printing composition and the photocurable printing composition has a viscosity of 25 centipoise or greater at 70 degrees Celsius.

8. The photocurable printing composition of claim 7, wherein the urethane acrylate oligomer is present from about 45% to 60% by weight based on a total weight of the photocurable printing composition and the photocurable printing composition has a viscosity of 82 centipoise or greater at 70 degrees Celsius.

9. The photocurable printing composition of claim 8, wherein the urethane acrylate oligomer is present from about 55% to 60% by weight based on a total weight of the photocurable printing composition and the photocurable printing composition has a viscosity of 180 centipoise or greater at 70 degrees Celsius.

10. The photocurable printing composition of claim 1, wherein the trifunctional acrylate ester monomer is trimethylolpropane triacrylate (TMPTA).

11. A method of forming a polishing pad, comprising:
sequentially forming a plurality of polymer layers, wherein forming the plurality of polymer layers comprises:
forming a first layer of first polishing elements of the polishing pad, wherein forming the first layer, comprises:
dispensing one or more droplets of a pre-polymer composition via an additive manufacturing process on a surface on which the first layer is formed, wherein the pre-polymer composition, comprises:
a urethane acrylate oligomer having a functionality of 2 or more, a nominal viscosity greater than 250 cP at 25 degrees Celsius, and a glass transition temperature (Tg) of −4 degrees Celsius or greater, the urethane acrylate oligomer present from about 20% to about 60% by weight based on a total weight of the pre-polymer composition;
an acrylate monomer mixture, comprising:
one or more monofunctional monomers selected from isobornyl acrylate, 3,3,5-Trimethylcyclohexyl acrylate (TMCHA), N-Vinyl-2-Pyrrolidone, N, N-Diethyl acrylamide (DEAA) or a combination thereof; and
one or more multifunctional monomers selected from a trifunctional acrylate ester monomer, 1,6-Hexanediol diacrylate, or a combination thereof, wherein the acrylate monomer mixture is present from 40% to 80% by weight based on a total weight of the pre-polymer composition and the pre-polymer composition has a viscosity of 20 centipoise or higher at 70 degrees Celsius; and
a photoinitiator.

12. The method of claim 11, wherein the pre-polymer composition has a viscosity in a range from about 25 centipoise to about 200 centipoise at 70 degrees Celsius.

13. The method of claim 11, wherein the urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius.

14. The method of claim 11, wherein the urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius.

15. The method of claim 11, wherein the urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius.

16. A polishing pad, comprising:
a plurality of polishing elements, each comprising:
an individual surface that forms a portion of a polishing surface of a polishing pad; and
one or more sidewalls extending downward from the individual surface to define a plurality of channels disposed between the polishing elements, wherein:
each of the polishing elements has a plurality of pore-features formed therein,
each of the polishing elements is formed of a pre-polymer composition, the pre-polymer composition comprising a urethane acrylate oligomer,
the pre-polymer composition has a Tan delta of about 1 or less, and
a storage modulus (E′) of the pre-polymer composition at a temperature of 30 degrees Celsius (E′30) is about 1000 MPa or less.

17. The polishing pad of claim 16, wherein the pre-polymer composition has a viscosity in a range from about 25 centipoise to about 200 centipoise at 70 degrees Celsius.

18. The polishing pad of claim 16, wherein the urethane acrylate oligomer has a functionality of 2, a nominal viscosity in a range from about 45,000 to about 90,000 cP at 60 degrees Celsius, and a Tg by DMA in a range from about −4 degrees Celsius to about 10 degrees Celsius.

19. The polishing pad of claim 16, wherein the urethane acrylate oligomer has a functionality of 2, a nominal viscosity in a range from about 19,000 to about 25,000 cP at 60 degrees Celsius, and a Tg by DMA in a range from about 30 degrees Celsius to about 45 degrees Celsius.

20. The polishing pad of claim 16, wherein the urethane acrylate oligomer has a functionality of 2, a nominal viscosity in a range from about 88,000 to about 94,000 cP at 25 degrees Celsius, and a Tg by DMA in a range from about 30 degrees Celsius to about 35 degrees Celsius.
